(19) United States
(12) Patent Application Publication
(10) Pub. No.: US 2010/0091842 A1
(43) Pub. Date: Apr. 15, 2010

(54) CODING RATE CONVERSION APPARATUS, CODING RATE CONVERSION METHOD, AND INTEGRATED CIRCUIT

(76) Inventors: Hiroshi Ikeda, Osaka (JP); Yoshiyuki Wada, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/519,604

(22) PCT Filed: Oct. 16, 2008
(86) PCT No.: PCT/JP2008/002943

§ 371 Date: Jun. 17, 2009

(30) Foreign Application Priority Data
Oct. 19, 2007 (JP) 2007-272119

(51) Int. Cl. H04N 7/26

(52) U.S. Cl. 375/240.03; 375/E07.139

(57) ABSTRACT

A plurality of macroblocks constituting coded data are inverse quantized using a first quantization matrix that is used when coding a picture, to obtain a plurality of sets of coefficient data. The first quantization matrix is converted to a second quantization matrix using a first conversion value and a second conversion value, where the first conversion value is for converting a low frequency coefficient corresponding to a frequency lower than a predetermined frequency among a plurality of coefficients shown by the first quantization matrix, and the second conversion value is for converting a high frequency coefficient among the plurality of coefficients and is larger than the first conversion value (Step S408). When the second quantization matrix is a matrix for increasing a coding rate of the coded data, a converted scale is calculated by multiplying a quantization scale corresponding to at least one macroblock by β1 (≧1). At least one part of the plurality of sets of coefficient data is quantized using the second quantization matrix and a calculated converted scale that corresponds to a macroblock corresponding to the at least one part of the plurality of sets of coefficient data.

### TECHNICAL FIELD

The present invention relates to a technique of converting a coding rate for a further reduction in information amount of coded data, and more specifically relates to a coding rate conversion apparatus and the like that suppress image quality degradation accompanying coding rate conversion.

### BACKGROUND ART

In recent years, Moving Picture Experts Group 2 (MPEG2) that achieves high compression is adopted as an image coding is technique. This technique is applied to digital broadcasting, DVDs, networks, and other recording media, and bitrates can be selected within a predetermined range according to applications.

For example, when selecting a bitrate for recording a digital broadcast of high image quality on a recording medium, more data can be recorded on the recording medium by converting a coding rate for a lower bitrate in order to reduce the information amount, instead of recording the data of high image quality directly on the recording medium. There is also a growing need for high-speed dubbing and the like that convert a coding rate to make efficient use of a capacity of a recording medium.

Moreover, when distributing a digital broadcast recorded on a recording medium over a network, video can be distributed even when the network has a narrow bandwidth by converting a coding rate for a lower bitrate according to the network bandwidth, instead of distributing the data of high image quality directly over the network.

One of the coding rate conversion methods for fulfilling the above is a requantization-type conversion method. This method, instead of decoding an input bit stream to a pixel level, requantizes Discrete Cosine Transform (DCT) coefficients after inverse quantization using a different quantization scale, thereby converting to a desired data amount. This allows for a reduction in coding rate without decoding to the pixel level.

Before describing the requantization-type coding rate conversion method in detail, DCT and quantization of MPEG2 are described in detail below.

In MPEG2, coded data of one picture is composed of one or more slices, and one slice is composed of one or more macroblocks (MBs). Hereafter, a macroblock is referred to as an MB. The MB has a header unit and a block unit. Hereafter, the header unit and the block unit of the MB are referred to as an MB header unit and an MB block unit, respectively. The MB block unit shows a plurality of quantized DCT coefficients. Quantized DCT coefficients are coefficients obtained by quantizing DCT coefficients that are generated as a result of performing a discrete cosine transform (DCT) on the picture in units of blocks of a predetermined size.

Moreover, one macroblock is composed of six blocks in total which are four luminance blocks and two chrominance blocks, in a standard format (4: 2: 0). The difference in the number of blocks between luminance and chrominance is based on the fact that the human visual system is more sensitive to luminance than chrominance in terms of density. In MPEG2, the six blocks are coded in an order of luminance Y (top left), luminance Y (top right), luminance Y (bottom left), luminance Y (bottom right), chrominance Cb (blue component), and chrominance Cr (red component).

One block is coded in a coefficient (quantized DCT coefficient) group of 8×8 in size. By performing inverse quantization and further performing an inverse DCT on this coefficient group, pixels of 8×8 in size can be decoded.

In the coefficient group included in the block, a top left coefficient is a low frequency component, coefficients toward the right are components of increasing frequencies in a horizontal direction, coefficients toward the bottom are components of increasing frequencies in a vertical direction, and a bottom right coefficient is a high frequency component in both the horizontal direction and the vertical direction. One coefficient at the top left corner is a DC component (direct current), and the other coefficients are AC components (alternating current).

A method of inverse quantizing the above quantized DCT coefficients differs between an Intra MB which is not subject to motion compensation and an Inter MB which is subject to motion compensation. The Intra MB is a macroblock in which data is compressed using information in a processing object picture. In the case of the Intra MB, the method also differs between a DC component and an AC component. The Inter MB is a macroblock in which data is compressed using information in a picture other than the processing object picture.

The DC component of the Intra MB is inverse quantized according to the following expression.

(DCT coefficient)=(inverse quantization coefficient)×(quantized DCT coefficient).

On the other hand, the AC component of the Intra MB is inverse quantized according to the following expression (hereafter referred to as an inverse quantization expression).

(DCT coefficient)=(2×(quantized DCT coefficient))×(quantization matrix)×(quantization scale)/32.

Meanwhile, the Inter MB is inverse quantized according to the following expression (hereafter referred to as an inverse quantization expression), regardless of the DC component or the AC component.

$$( DCT coefficient ) = ( 2 \times ( quantized DCT coefficient ) + 1 ) \times ( quantization matrix ) \times ( quantization scale ) / 32 ( where ( quantized DCT coefficient ) > 0 ) ( 2 \times ( quantized DCT coefficient ) ) \times ( quantization matrix ) \times ( quantization scale ) / 32 ( where ( quantized DCT coefficient ) = 0 ) ( 2 \times ( quantized DCT coefficient ) - 1 ) \times ( quantization matrix ) \times ( quantization scale ) / 32 ( where ( quantized DCT coefficient ) < 0 ) .$$

In the above expressions, the inverse quantization coefficient or the quantization scale is a coefficient (scalar), whereas the quantization matrix is composed of a coefficient group (vector) of 8×8 in size from which a coefficient corresponding to a position of a DCT coefficient to be calculated is submitted for use.

The inverse quantization coefficient and the quantization matrix are designated in units of pictures, and the quantization scale is designated in units of macroblocks.

Moreover, the quantization scale is not coded as it is, but is converted from a coded quantization scale code (quantization parameter) shown by the MB header unit, with reference to a table shown in FIG. 1. The conversion from the quantization scale code (quantization parameter) to the quantization scale has two types, namely, a linear type and a nonlinear type. Which type is used for coding is designated in units of pictures.

Next, only nonzero coefficients of quantized DCT coefficients are coded in an order specified by one of zigzag scan shown in FIG. 2A and alternate scan shown in FIG. 2B. Which scan order is used is designated in units of pictures. The zigzag scan is suitable for coding a progressive image, whilst the alternate scan is suitable for coding an interlaced image. Though the zigzag scan is used in the following description, the same applies to the alternate scan.

Nonzero coefficients are coded in the following manner. The number of entries from an immediately preceding nonzero coefficient, denoted by run (=the number of consecutive zero coefficients), and a value of a nonzero quantized DCT coefficient, denoted by level, are coded. Following a last nonzero coefficient, an End Of Block (EOB) is coded, and subsequent zero coefficients are omitted. For instance, in a block of quantized DCT coefficients in an order of, beginning from a low frequency component, 7, 3, 0, 0, 1, and all 0 thereafter, coding is performed in an order of (run, level)=(0, 7), (0, 3), (2, 1), and EOB.

The following describes the requantization-type coding rate conversion method in detail (see Patent Reference 1).

FIG. 3 is a block diagram showing a structure of an example of an MPEG2 decoding apparatus 10000. A variable length decoding unit 2201 decodes an MPEG2 stream, and notifies information (quantized DCT coefficients) shown by each of a plurality of MB block units obtained by the decoding to an inverse quantization unit 2202.

In the case of the Intra MB, the inverse quantization unit 2202 inverse quantizes the quantized DCT coefficients back to DCT coefficients, and notifies the DCT coefficients to an inverse DCT unit 2203. The inverse DCT unit 2203 performs an inverse DCT, to return the DCT coefficients to pixel information. The pixel information is outputted through a pixel restoration unit 2206. The pixel information is also stored in a reference frame storage unit 2204, since there is a possibility that the pixel information is referenced when processing a next picture onward.

In the case of the Inter MB, pixel information obtained as a result of an inverse DCT is a difference, so that a further process is necessary after DCT coefficients are outputted to the pixel restoration unit 2206. A motion compensation unit 2205 obtains, from the reference frame storage unit 2204, a reference image designated by a motion vector decoded by the variable length decoding unit 2201, and notifies the reference image to the pixel restoration unit 2206. The pixel restoration unit 2206 adds the reference image and the difference of the pixel information to calculate pixel information, and outputs the calculated pixel information. The restored pixel information is stored in the reference frame storage unit 2204 as in the case of the Inter MB.

FIG. 4 is a block diagram showing a structure of an example of an MPEG2 coding apparatus 10001. The MPEG2 coding apparatus 10001 basically has a reverse structure of the MPEG decoding apparatus 10000.

In the case of the Intra MB, pixel information is first subject to a DCT in a DCT unit 2301, and information obtained as a result of the DCT is notified to a quantization unit 2302. A rate control unit 2311 calculates a quantization scale while correcting a target coding rate using an achieved value of an actual coded bit amount obtained from a variable length coding unit 2303, and notifies the quantization scale to the quantization unit 2302.

The quantization unit 2302 quantizes DCT coefficients using the quantization scale calculated by the rate control, and simultaneously notifies the quantized information to the variable length coding unit 2303 and an inverse quantization unit 2304 so as to be used as a reference image. The variable length coding unit 2303 codes the quantized DCT coefficients as a stream. For use as a reference image for a next picture onward, the quantized DCT coefficients are decoded to image information by the inverse quantization unit 2304 and an inverse DCT unit 2305, and the image information is stored in a reference frame storage unit 2306, in the same way as the decoding apparatus 10000.

In the case of the Inter MB, for a reduction in image is information amount using a reference image, first a motion detection unit 2307 detects an image having a high degree of coincidence with an input image from the reference frame storage unit 2306, and calculates a motion vector. The motion vector is notified to a motion compensation unit 2308, and also notified to the variable length coding unit 2303 so as to be coded as MB header unit information of a stream. The motion compensation unit 2308 obtains a reference image from the reference frame storage unit 2306 on the basis of the motion vector, and a pixel subtraction unit 2309 calculates a difference from the input image to thereby reduce the information amount. The subsequent process is the same as the case of the Intra MB.

For use as a reference image for a next picture onward, the difference in image information is calculated through the inverse quantization unit 2304 and the inverse DCT unit 2305, the reference image obtained by the motion compensation unit 2308 is added to the difference by a pixel addition unit 2310 to allow the image information to be decoded, and the image information is stored in the reference frame storage unit 2306.

In MPEG2, the bit amount of the MB header unit is approximately within a fixed range, and makes up only a small proportion of an entire coded stream. Conversely, the bit amount of the MB block unit varies greatly from one MB to another, and also makes up a large proportion of the coded stream. Accordingly, to reduce a coding rate of the coded stream, a method of reducing a quantized DCT coefficient (level) in the MB block unit by some means is effective.

When the quantized DCT coefficient (level) is reduced, such a small level can be represented by coded bits of a short length. Furthermore, when the level is reduced to 0, the coding of the level itself becomes unnecessary, with it being possible to reduce the coding rate.

A requantization-type rate conversion apparatus is a conversion apparatus that makes use of the above property of quantization, and has a structure of integrating the MPEG decoding apparatus and the MPEG coding apparatus while omitting unnecessary parts. Since the rate is converted only by quantization without decoding the stream to the image level, there is an advantage that a DCT and motion compensation need not be performed.

As can be understood from the aforementioned inverse quantization expressions, quantized DCT coefficients (level) can be reduced by increasing any of the quantization scale and the quantization matrix. First, a quantization scale reconversion-type coding rate conversion apparatus is described in detail below, as an example of the requantization-type coding rate conversion apparatus.

FIG. 5 is a block diagram of a quantization scale reconversion-type coding rate conversion apparatus 11000.

A variable length decoding unit 2401 decodes an MPEG2 stream. The variable length decoding unit 2401 does not convert a picture header including an inverse quantization coefficient or a quantization matrix, and notifies the picture header directly to a variable length coding unit 2402 (not illustrated). The variable length coding unit 2401 notifies parameters of an MB header unit to an MB header storage unit 2405 and, simultaneously with this, converts a quantization scale code shown by the MB header unit to a quantization scale and notifies the quantization scale to a quantization scale increase conversion unit 2404. The variable length decoding unit 2401 notifies parameters shown by an MB block unit such as quantized DCT coefficients, to an inverse quantization unit 2406.

The inverse quantization unit 2406 performs inverse quantization according to the quantization scale of the input stream, and notifies a result to a quantization unit 2407.

Meanwhile, a rate control unit 2403 calculates a target quantization scale according to a target conversion rate, and notifies the calculated target quantization scale to the quantization scale increase conversion unit 2404.

The quantization scale increase conversion unit 2404 converts the quantization scale at the time of input to a new quantization scale at the time of output, with reference to the target quantization scale. The quantization scale increase conversion unit 2404 simultaneously notifies the converted quantization scale to the quantization unit 2407 and the MB header storage unit 2405.

The MB header storage unit 2405 converts the quantization scale to a quantization scale code, and rewrites the existing value to the new value. The MB header storage unit 2405 notifies the parameter corresponding to the MB header, to the variable length coding unit 2402. Thus, an MB header unit stream is obtained.

Moreover, the quantization unit 2407 performs quantization according to the new quantization scale, and notifies quantized DCT coefficients obtained by the quantization to the variable length coding unit 2402. Thus, an MB block unit stream is obtained.

The rate control unit 2403 obtains the decoded bit amount from the variable length decoding unit 2401, obtains the coded bit amount from the variable length coding unit 2402, and corrects the target rate, whenever necessary.

The following describes the rate control in the quantization scale reconversion-type coding rate conversion apparatus 11000 in detail.

In MPEG2, a rate control method upon coding is defined in Test Model 5, ISO-IEC/JTC1/SC29/WG11/N0400 (hereafter referred to as TM5). In coding rate conversion, too, the same method as TM5 is often employed (see Patent Reference 1). Accordingly, TM5 is described first. The rate control method of TM5 is made up of three steps.

Step 1 is a phase of performing bit allocation to each picture from a target bitrate. Step 2 is a phase of calculating a quantization scale on the basis of bits allocated to each picture. Step 3 is a phase of correcting the quantization scale in consideration of visual properties.

In Step 1, bit allocation is made to each picture according to a target coding rate, a picture structure (I, P, B picture), and the like as defined by mathematical expressions, though this does not directly relate to the present invention and so its detail is omitted.

In Step 2, assuming a virtual reference decoding unit, rate control for a virtual buffer is carried out. In this rate control process, a process for matching bit amounts Ti, Tp, and Tb allocated to I, P, and B pictures and bit amounts Si, Sp, and Sb actually generated in I, P, and B pictures respectively with each other is performed. In detail, a quantization scale is calculated by feedback control in units of macroblocks, on the basis of three virtual buffer capacities separately set for the different picture types. Occupancy di(j), dp(j), or db(j) of the virtual buffer used when coding the j-th macroblock in the I, P, or B picture is given by the following expression.

dk(j)=dk(0)+B(j−1)−Tk×(j−1)/NMB (where k=i,p,b).

Here, di(0), dp(0), and db(0) each denote initial occupancy of the virtual buffer. B(j−1) is a total amount of code generated up to the (j−1)-th macroblock. NMB is the number of macroblocks in the picture. On the basis of the above virtual buffer occupancy, quantization scale mqi(j), mqp(j), or mqb(j) of the j-th macroblock in the I, P, or B picture is given by the following expression.

mqk(j)=dk(j)×31/r (where k=i,p,b).

Here, r is a constant called the reaction parameter. Step 3 does not directly relate to the present invention, and so its detail is omitted.

The following describes the quantization scale conversion in the quantization scale reconversion-type coding rate conversion apparatus in detail.

The quantization scale is obtained as a result of the rate control. However, it is not necessarily desirable to use the quantization scale itself in coding rate conversion. For example, TM5 calculates the quantization scale without reference to the input stream. This being so, a situation where quantization scale mqk(j) obtained by the rate control is smaller than quantization scale qik(j) of the input stream occurs. In such a case, when mqk(j) itself is used as the quantization scale, a larger amount of bits than the input stream will end up being outputted.

However, as long as converting the input stream and outputting the converted stream as the output stream, it is impossible that the output stream has smaller quantization errors than the input stream. Therefore, this increase in bit amount is totally meaningless. Hence quantization scale qok(j) of the output stream is desirably set as follows.

qok(j)=max{qik(j),mqk(j)} (where k=i,p,b).

In addition, there is also a report that image quality degradation per the same code amount can be reduced by setting quantization scale qok(j) of the output stream as follows, rather than by directly using quantization scale mqk(j) obtained by the rate control as qok(j) (see Patent Reference 2).

$$qok ( j ) = qik ( j ) ( where mqk ( j ) < 1.5 \times qik ( j ) ) 2 \times qik ( j ) ( where 1.5 \times qik ( j ) \leq mqk ( j ) < 2 \times qik ( j ) ) mqk ( j ) ( where 2 \times qik ( j ) < mqk ( j ) ) ( where k = i , p , b ) .$$

In any case, the quantization scale of the output stream can be obtained by referencing the quantization scale obtained by the rate control and converting the quantization scale of the input stream in an increasing direction, instead of directly using the quantization scale obtained by the rate control.

The following describes a specific example of quantization in the quantization scale reconversion-type coding rate conversion apparatus 11000, with reference to FIG. 6.

Suppose the quantization scale is converted from 4 to 8, that is, converted by 2 times, as a result of the rate control and the quantization scale conversion. With reference to the above inverse quantization expressions, quantized DCT coefficients need to be approximately in inverse proportion to the quantization scale, and so the quantized DCT coefficients need to be converted by ½ times.

In a block of an Inter MB where eight nonzero quantized DCT coefficients (level) 7, −3, 2, 1, 4, 1, −1, and 1 are present, it is basically desirable to convert them to 3.5, −1.5, 1, 0.5, 2, 0.5, −0.5, and 0.5. However, quantized DCT coefficients can be coded only in integers. Accordingly, 3.5, −1.5, 1, 0.5, 2, 0.5, −0.5, and 0.5 are respectively converted to integers 3, −1, 1, 0, 2, 0, 0, and 0 (the fractional portions are dropped here), as a result of which the value of level decreases.

Moreover, the number of nonzero coefficients decreases from eight before conversion to four after conversion. When this block is coded, the code amount which is 50 bits at the time of input can be reduced to 25 bits. Thus, the coding rate can be reduced.

The conversion to the integers (dropping the fractional portions), however, causes errors (quantization errors). The quantization scale is a coefficient which acts upon all frequency components of the quantized DCT coefficients. This being so, there is a possibility that errors uniformly occur in all frequencies from low frequency components to high frequency components. In particular, the human eye is extremely sensitive to errors in low frequency components, and these errors are observed as block noise.

In the quantization scale reconversion-type coding rate conversion apparatus, the coding rate needs to be controlled only by the quantization scale. Accordingly, to achieve the target coding rate, it is necessary to increase a quantization scale conversion factor. This incurs a possibility that block noise due to the aforementioned errors in low frequency components occurs extensively. The quantization scale conversion factor mentioned here is a value for converting the quantization scale.

On the other hand, as the requantization-type coding rate conversion method, not only the quantization scale reconversion-type coding rate conversion method but also a quantization matrix reconversion-type coding rate conversion method is available (see Patent Reference 3).

The quantization matrix is a coefficient group of a block size (8×8). Unlike the quantization scale, the quantization matrix has an independent coefficient for each frequency component. Therefore, by changing a conversion factor for each frequency component so as to restrict quantization errors, it may be possible to solve the problem of the quantization scale reconversion-type coding rate conversion apparatus.

FIG. 7 shows a quantization matrix reconversion-type coding rate conversion apparatus 12000.

A variable length decoding unit 2501 decodes an MPEG2 stream. The variable length decoding unit 2501 simultaneously notifies a picture header including a quantization matrix obtained by the decoding, to a picture header storage unit 2505 and a quantization matrix high-range increase conversion unit 2504.

A rate control unit 2503 notifies a target code amount of a picture to the quantization matrix high-range increase conversion unit 2504, on the basis of a target conversion rate.

The quantization matrix high-range increase conversion unit 2504 converts coefficients of high frequency components (high range) in the quantization matrix of the input stream in an increasing direction, on the basis of control information. The quantization matrix high-range increase conversion unit 2504 simultaneously notifies the quantization matrix after the conversion showing the converted coefficients, to a quantization unit 2507 and the picture header storage unit 2505.

The picture header storage unit 2505 notifies the picture header to a variable length coding unit 2502. Thus, a picture header stream is obtained.

Next, as an MB process, the variable length decoding unit 2501 directly notifies an MB header to the variable length coding unit 2502 (not illustrated). The variable length decoding unit 2501 also notifies parameters of an MB block unit such as quantized DCT coefficients, to an inverse quantization unit 2506.

The quantization unit 2507 performs quantization according to the new quantization matrix, and notifies quantized DCT coefficients obtained as a result to the variable length coding unit 2502. Thus, an MB block unit stream is obtained.

After the process is completed for all MBs, the rate control unit 2503 obtains the decoded bit amount from the variable length decoding unit 2501, obtains the coded bit amount from the variable length coding unit 2502, and corrects the target rate.

The following describes the rate control in the quantization matrix reconversion-type coding rate conversion apparatus in detail.

The calculation of the target code amount of the picture can be performed by applying Step 1 of TM5 as in the quantization scale reconversion-type coding rate conversion apparatus 11000, and so its description is omitted here.

On the other hand, though the quantization scale reconversion-type coding rate conversion apparatus 11000 uses Step 2 of TM5 for the control in units of macroblocks, this is a method for changing the quantization scale, and therefore cannot be applied to the quantization matrix reconversion-type coding rate conversion method.

The following describes the quantization matrix conversion in the quantization matrix reconversion-type coding rate conversion apparatus 12000 in detail.

As an example of controlling the quantization matrix conversion, a quantization matrix intensity of the i-th picture out of I, P, and B pictures is denoted by wi(i), wp(i), or wb(i), and consider the case of controlling the intensity on the basis of an achieved value (a difference between a target and a coding result) of a preceding picture.

$$wk ( i ) = max \{ 1 , wk ( i - 1 ) + 1 \} ( where Bk ( i - 1 ) < Tk ( i - 1 ) + C ) wk ( i - 1 ) ( where Tk ( i - 1 ) - C \leq Bk ( i - 1 ) \leq Tk ( i - 1 ) + C ) min \{ 4 , wk ( i - 1 ) - 1 \} ( where Tk ( i - 1 ) - C < Bk ( i - 1 ) ) ( where k = i , p , b ) .$$

Here, Ti(i−1), Tp(i−1), and Tb(i−1) are each a constant showing a target code amount of the (i−1)-th picture out of I, P, and B pictures, Bi(i−1), Bp(i−1), and Bb(i−1) are each a constant showing an actual code amount of the (i−1)-th picture out of I, P, and B pictures. C is a constant showing a permissible code amount as a difference between a target value and an actual value. According to the above expression, the quantization matrix is controlled so that its intensity is decreased when the target coding rate is achieved, and increased when the target coding rate is not achieved.

Next, coefficients of the quantization matrix of the input stream are converted to coefficients of the quantization matrix of the output stream according to the following expression (hereafter referred to as a matrix conversion expression). Note that the quantization matrix of each of the output stream and the input stream is assumed to be a matrix of 8 rows and 8 columns.

$$Wo ( u , v ) = Wi ( u , v ) ( where u + v \leq ɛ ( low frequency component ) ) wk ( i ) \times Wi ( u , v ) ( where u + v > ɛ ( high frequency component ) ) ( where k = i , p , b ) .$$

Here, Wi(u, v) is a constant showing the (u, v)-th coefficient (u=0 to 7, v=0 to 7) of the quantization matrix of the input stream. Wo(u, v) is a constant showing the (u, v)-th coefficient of the quantization matrix of the output stream. Wo(u, v) also shows the coefficient specified by row (v+1) and column (u+1). For instance, when u=2 and v=5, Wo(u, v) shows the coefficient specified by row 6 and column 3. ε is a constant showing a threshold (reference frequency) for suppressing errors.

The following describes a specific example of quantization in the quantization matrix reconversion-type coding rate conversion apparatus 12000, with reference to FIG. 8.

Suppose coefficients of high frequency components of to the quantization matrix (where E=2) are increased by 2 times as a result of the rate control and the quantization matrix conversion. Let ε=2 in the above matrix conversion expression. In this case, six coefficients located in a top left triangle out of 64 coefficients shown by the quantization matrix are coefficients of low frequency components of the quantization matrix, and coefficients other than the six coefficients located in the top left triangle out of the 64 coefficients shown by the quantization matrix are coefficients of high frequency components of the quantization matrix.

With reference to the above inverse quantization expressions, quantized DCT coefficients need to be approximately in inverse proportion to the quantization matrix, and so quantized DCT coefficients of high frequency components need to be converted by ½ times.

Consider the case of converting a block of an Inter MB where a total of eight nonzero quantized DCT coefficients 7, −3, 2, 1, 4, 1, −1, and 1 are present and the first three out of the eight nonzero quantized DCT coefficients correspond to low frequency components. The coefficients of the low frequency components need not be converted. Meanwhile, though it is basically desirable to convert the quantized DCT coefficients of the high frequency components to 0.5, 2, 0.5, −0.5, and 0.5, they are respectively converted to integers 0, 2, 0, 0, and 0.

As a result, no quantization errors occur in the low frequency components of the quantized DCT coefficients, and also the code amount which is 50 bits at the time of input is reduced to 35 bits by the reduction in level of nonzero quantized DCT coefficients and the reduction of the number of nonzero coefficients in the high frequency components. In this way, the coding rate can be reduced while suppressing image quality degradation caused by quantization errors in low frequency components.

In the coding rate conversion apparatus 12000, however, since the quantization matrix can be set only in units of pictures, the coding rate cannot be controlled finely, and in the worst case the coding rate can only be converged to the target rate after several tens of pictures.

For example, in the case of applying the coding rate conversion apparatus 12000 to coding rate conversion that is based on a network bandwidth, it is required to keep up with the coding rate at least in units of pictures or in units of GOPs. However, the coding rate conversion apparatus 12000 cannot meet this requirement, and image distortion may be caused by distributing a stream that exceeds the network bandwidth over a predetermined time period.

Besides, in MPEG2 the bit amount per picture is defined as a buffer model, and accordingly the bit amount needs to be controlled so as to be within the range of the standard in units of pictures. The coding rate conversion apparatus 12000 has difficulty in realizing this control, and there is even a possibility that a stream violating the standard is outputted.

There is also a coding rate conversion method (combined method) that combines the quantization scale reconversion-type coding rate conversion method and the quantization matrix reconversion-type coding rate conversion method described above (see Patent Reference 1).

FIG. 9 shows a coding rate conversion apparatus 13000 of the combined method (hereafter referred to as combined type) of the quantization scale reconversion type and the quantization matrix reconversion type.

The coding rate conversion apparatus 13000 has a structure that simply combines the quantization scale reconversion-type coding rate conversion apparatus 11000 shown in FIG. 5 and the quantization matrix reconversion-type coding rate conversion apparatus 12000 shown in FIG. 7, and so its description is omitted here.

Moreover, the rate control, quantization matrix conversion, and quantization parameter conversion in the combined-type coding rate conversion apparatus 13000 can be performed by the same methods as the quantization scale reconversion-type coding rate conversion apparatus 11000 and the quantization matrix reconversion-type coding rate conversion apparatus 12000, and so their description is omitted here.

The following describes a specific example of quantization in the combined-type coding rate conversion apparatus 13000, with reference to FIG. 10.

Suppose coefficients of high frequency components of the quantization matrix (where ε=2) are increased by 2 times as a result of the rate control and the quantization matrix conversion, and also the quantization scale is increased from 4 to 8, that is, increased by 2 times, as a result of the rate control and the quantization scale conversion.

With reference to the above inverse quantization expressions, quantized DCT coefficients need to be approximately in inverse proportion to the quantization matrix and the quantization scale. To do so, coefficients of low frequency components need to be converted by 1×½=½ times, and coefficients of high frequency components need to be converted by ½×½=¼ times.

Consider the case of converting a block of an Inter MB where a total of eight nonzero quantized DCT coefficients 7, −3, 2, 1, 4, 1, −1, and 1 are present and the first three out of the eight nonzero quantized DCT coefficients correspond to low frequency components. In this case, the coefficients of the low frequency components are converted to 3, −1, and 1 as a result of converting 3.5, −1.5, and 1 to integers. The coefficients of the high frequency components are converted to 0, 1, 0, 0, and 0 as a result of converting 0.25, 1, 0.25, −0.25, and 0.25 to integers. In this way, the code amount which is 50 bits at the time of input can be reduced to 20 bits.

As can be understood from the above, the combined-type coding rate conversion apparatus 13000 has the combined features of both the quantization scale reconversion-type coding rate conversion apparatus 11000 and the quantization matrix reconversion-type coding rate conversion apparatus 12000. In addition, the coding rate conversion apparatus 13000 can perform conversion while correcting a deviation from the target rate in units of macroblocks by changing the quantization scale. Accordingly, the coding rate conversion apparatus 13000 can solve the problem of the quantization matrix reconversion method that cannot control the coding rate finely.

Furthermore, the coding rate conversion apparatus 13000 can reduce the code amount not only by quantization scale conversion but also by quantization matrix conversion. Since no quantization errors occur in low frequency components by quantization matrix conversion, the occurrence of quantization errors in low frequency components by quantization scale conversion can be reduced for the same coding rate. Hence the coding rate conversion apparatus 13000 can solve the problem of the quantization scale reconversion method that causes extensive quantization errors in low frequency components.

That is, the above combined-type coding rate conversion apparatus 13000 is capable of converting the quantization scale and the quantization matrix in a manner that complements the drawbacks of the quantization scale reconversion method and the quantization matrix reconversion method.

### Patent Reference 1: Japanese Unexamined Patent Application Publication No. 2001-078194

### Patent Reference 2: Japanese Unexamined Patent Application Publication No. 2001-204028

### Patent Reference 3: Japanese Unexamined Patent Application Publication No. 2005-210502

### DISCLOSURE OF INVENTION

### Problems that Invention is to Solve

Quantization errors in low frequency components of DCT coefficients can be suppressed by using the above combined-type coding rate conversion apparatus 13000. In the coding rate conversion apparatus 13000, however, when quantization errors occur in high frequency components of DCT coefficients, there is also a tendency of image quality degradation such as a drop in screen fineness and an appearance of mosquito noise, though to a lesser extent than low frequency components.

Typically, there is a tradeoff relation between the coding rate and the image quality. Accordingly, at a block level, the reduction of the coding rate and the image quality degradation due to quantization errors in high frequency components are inevitable. At a picture level, however, this does not necessarily hold true.

Suppose the resolution differs in one picture as in an image where a small figure of a person is shown at a high resolution against a flat, low-resolution background. In such a case, overall image quality degradation may be able to be suppressed more by reducing quantization errors in high frequency components of DCT coefficients in a high-resolution MB corresponding to the image of the person, rather than by reducing quantization errors in low frequency components of DCT coefficients in a low-resolution MB corresponding to the image of the background.

This being so, it is desirable to perform such control that suppresses quantization errors including high frequency coefficients in the high-resolution MB, and reduces the code amount in the low-resolution MB to make up for any lack of code amount reduction in the high-resolution MB.

In the above combined-type coding rate conversion apparatus 13000, however, even when the quantization scale control is performed with such weighting that does not increase the quantization scale in the high-resolution MB and greatly increases the quantization scale in the low-resolution MB, the high frequency components of the quantization matrix are increased in the picture header, so that quantization errors still occur in high frequency components even in the case of not increasing the quantization scale.

Which is to say, the combined-type coding rate conversion apparatus 13000 cannot realize such coding rate conversion that suppresses image quality degradation caused by quantization errors in low frequency components of DCT coefficients in all MBs, and further suppresses image quality degradation caused by quantization errors in not only low frequency components but also high frequency components of DCT coefficients in a specific MB such as a high-resolution MB.

Although the above description is based on MPEG2, the same problem exists in any image codec which performs coding according to an orthogonal transform such as a DCT and designates a quantization matrix in units of pictures and a quantization scale in units of macroblocks. Examples of the image codec include JPEG, MPEG1, MPEG4, H.264, and so on.

The present invention has been developed to solve the above problems, and has an object of providing a coding rate conversion apparatus and the like that can suppress image quality degradation caused by quantization errors in low frequency components, and further suppress image quality degradation caused by quantization errors in high frequency components in a specific macroblock.

### Means to Solve the Problems

To achieve the stated object, a coding rate conversion apparatus according to an aspect of the present invention is an apparatus that converts a coding rate of coded data of a picture, the coded data being obtained by performing at least a quantization process using a result of multiplying a quantization matrix and a quantization scale in a process of coding the picture. The quantization scale is set for each of a plurality of macroblocks constituting the coded data for restoring the picture. The quantization matrix is set for the picture obtained from the coded data. The coding rate conversion apparatus includes: an inverse quantization unit that obtains a plurality of sets of coefficient data, by inverse quantizing the plurality of macroblocks using a first quantization matrix that is used when coding the picture; a quantization matrix conversion unit that converts the first quantization matrix to a second quantization matrix using a first conversion value and a second conversion value, the first conversion value being for converting a low frequency coefficient which is a coefficient corresponding to a frequency lower than a predetermined frequency among a plurality of coefficients shown by the first quantization matrix, the second conversion value being for converting a high frequency coefficient which is a coefficient other than the low frequency coefficient among the plurality of coefficients, the second conversion value being larger than the first conversion value; a scale calculation unit that calculates a converted scale obtained by multiplying a quantization scale corresponding to at least one of the plurality of macroblocks by β1 where β1≧1, when the second quantization matrix is a matrix for increasing the coding rate of the coded data, and calculates a converted scale obtained by multiplying the quantization scale corresponding to the at least one of the plurality of macroblocks by β2 where 0<β2<1, when the second quantization matrix is a matrix for decreasing the coding rate of the coded data; and a requantization unit that generates the coded data having a coding rate lower than a coding rate prior to the inverse quantization by the inverse quantization unit, by quantizing at least one part of the plurality of sets of coefficient data using the second quantization matrix and a calculated converted scale that corresponds to a macroblock corresponding to the at least one part of the plurality of sets of coefficient data.

A coding rate conversion method according to another aspect of the present invention is a method for converting a coding rate of coded data of a picture, the coded data being obtained by performing at least a quantization process using a result of multiplying a quantization matrix and a quantization scale in a process of coding the picture. The quantization scale is set for each of a plurality of macroblocks constituting the coded data for restoring the picture. The quantization matrix is set for the picture obtained from the coded data. The coding rate conversion method includes: obtaining a plurality of sets of coefficient data, by inverse quantizing the plurality of macroblocks using a first quantization matrix that is used when coding the picture; converting the first quantization matrix to a second quantization matrix using a first conversion value and a second conversion value, the first conversion value being for converting a low frequency coefficient which is a coefficient corresponding to a frequency lower than a predetermined frequency among a plurality of coefficients shown by the first quantization matrix, the second conversion value being for converting a high frequency coefficient which is a coefficient other than the low frequency coefficient among the plurality of coefficients, the second conversion value being larger than the first conversion value; calculating a converted scale obtained by multiplying a quantization scale corresponding to at least one of the plurality of macroblocks by β1 where β1≧1, when the second quantization matrix is a matrix for increasing the coding rate of the coded data, and calculating a converted scale obtained by multiplying the quantization scale corresponding to the at least one of the plurality of macroblocks by β2 where 0<β2<1, when the second quantization matrix is a matrix for decreasing the coding rate of the coded data; and generating the coded data having a coding rate lower than a coding rate prior to the inverse quantization, by quantizing at least one part of the plurality of sets of coefficient data using the second quantization matrix and a calculated converted scale that corresponds to a macroblock corresponding to the at least one part of the plurality of sets of coefficient data.

With the coding rate conversion apparatus and the coding rate conversion method according to the present invention, a plurality of macroblocks constituting coded data are inverse quantized using a first quantization matrix that is used when coding a picture, to obtain a plurality of sets of coefficient data. The first quantization matrix is converted to a second quantization matrix using a first conversion value and a second conversion value. The first conversion value is a value for converting a low frequency coefficient corresponding to a frequency lower than a predetermined frequency among a plurality of coefficients shown by the first quantization matrix, and the second conversion value is a value for converting a high frequency coefficient among the plurality of coefficients and is larger than the first conversion value.

When the second quantization matrix is a matrix for increasing a coding rate of the coded data, a converted scale is calculated by multiplying a quantization scale corresponding to at least one macroblock by β1 (≧1). At least one part of the plurality of sets of coefficient data is quantized using the second quantization matrix and a calculated converted scale that corresponds to a macroblock corresponding to the at least one part of the plurality of sets of coefficient data.

Here, the second quantization matrix, which is obtained by converting the first quantization matrix using the first conversion value for converting the low frequency coefficient and the second conversion value for converting the high frequency coefficient and larger than the first conversion value, is a matrix in which the low frequency coefficient is smaller than the high frequency coefficient.

Which is to say, the second quantization matrix used for the quantization is a matrix in which the low frequency coefficient is smaller than the high frequency coefficient. Note that the quantization matrix is set in units of pictures. When coefficients in the quantization matrix used for the quantization are smaller, quantization errors in the quantization are smaller.

Moreover, when the second quantization matrix is a matrix for increasing the coding rate of the coded data, the converted scale calculated by multiplying the quantization scale corresponding to at least one macroblock by β1 (≧1) is used for the quantization. Note that the quantization scale is set for each of a plurality of macroblocks. All coefficients of the quantization matrix before being used for the quantization are multiplied by the quantization scale. Therefore, when the quantization scale is smaller, quantization errors in the quantization are smaller.

Suppose the converted scale used for the quantization is a value obtained by multiplying the quantization scale corresponding to at least one macroblock by 1. In such a case, all coefficients (coefficients of low frequency components and high frequency components) in the second quantization matrix used for the quantization are unchanged.

Accordingly, by performing the quantization using the second quantization matrix in which the low frequency coefficient is smaller than the high frequency coefficient, the occurrence of quantization errors in low frequency components can be suppressed, and also the occurrence of quantization errors in high frequency components in at least one macroblock can be suppressed. This makes it possible to suppress image quality degradation caused by quantization errors in low frequency components, and further suppress image quality degradation caused by quantization errors in high frequency components in a specific macroblock.

Note that the present invention can also be realized as a program for causing a computer to execute the process of the coding rate conversion method. The present invention can also be realized as a computer readable recording medium on which the program is stored, and as an integrated circuit.

### EFFECTS OF THE INVENTION

According to the present invention, a plurality of macroblocks constituting coded data are inverse quantized using a first quantization matrix that is used when coding a picture, to obtain a plurality of sets of coefficient data. The first quantization matrix is converted to a second quantization matrix so that, among a plurality of coefficients shown by the first quantization matrix, a low frequency coefficient corresponding to a frequency lower than a predetermined frequency becomes smaller than a high frequency coefficient. When the second quantization matrix is a matrix for increasing a coding rate of the coded data, a converted scale is calculated by multiplying a quantization scale corresponding to at least one macroblock by −1 (≧1). At least one part of the plurality of sets of coefficient data is quantized using the second quantization matrix and a calculated converted scale that corresponds to a macroblock corresponding to the at least one part of the plurality of sets of coefficient data.

Which is to say, the second quantization matrix used for the quantization is a matrix in which the low frequency coefficient corresponding to the frequency lower than the predetermined frequency is smaller than the high frequency coefficient. When coefficients in the quantization matrix used for the quantization are smaller, quantization errors in the quantization are smaller.

Moreover, when the second quantization matrix is a matrix for increasing the coding rate of the coded data, the converted scale calculated by multiplying the quantization scale corresponding to at least one macroblock by β1 (≧1) is used for the quantization. Note that all coefficients of the quantization matrix are multiplied by the quantization scale. Therefore, when the quantization scale is smaller, quantization errors in the quantization are smaller.

Suppose the converted scale used for the quantization is a value obtained by multiplying the quantization scale corresponding to at least one macroblock by 1. In such a case, all coefficients (coefficients of low frequency components and high frequency components) in the second quantization matrix used for the quantization are unchanged.

Accordingly, by performing the quantization using the second quantization matrix in which the low frequency coefficient is smaller than the high frequency coefficient, the occurrence of quantization errors in low frequency components can be suppressed, and also the occurrence of quantization errors in high frequency components in at least one macroblock can be suppressed. This makes it possible to suppress image quality degradation caused by quantization errors in low frequency components, and further suppress image quality degradation caused by quantization errors in high frequency components in a specific macroblock.

### BRIEF DESCRIPTION OF DRAWINGS

FIG. 1 shows a correspondence between a quantization scale and a quantization parameter in MPEG2.

FIG. 2A shows a coding order (scan order) of DCT coefficients in MPEG2.

FIG. 2B shows a coding order (scan order) of DCT coefficients in MPEG2.

FIG. 3 is a block diagram showing a structure of an example of an MPEG2 decoding apparatus.

FIG. 4 is a block diagram showing a structure of an example of an MPEG2 coding apparatus.

FIG. 5 is a block diagram showing a structure of an example of a conventional quantization scale reconversion-type coding rate conversion apparatus.

FIG. 6 shows an example of MB conversion in the conventional quantization scale reconversion-type coding rate conversion apparatus.

FIG. 7 is a block diagram showing a structure of an example of a conventional quantization matrix reconversion-type coding rate conversion apparatus.

FIG. 8 shows an example of MB conversion in the conventional quantization matrix reconversion-type coding rate conversion apparatus.

FIG. 9 is a block diagram showing a structure of an example of a coding rate conversion apparatus that combines the conventional quantization scale reconversion type and quantization matrix reconversion type.

FIG. 10 shows an example of MB conversion in the coding rate conversion apparatus that combines the conventional quantization scale reconversion type and quantization matrix reconversion type.

FIG. 11 is a block diagram showing a structure of a coding rate conversion apparatus in a first embodiment of the present invention.

FIG. 12 is a flowchart of a coding rate conversion process.

FIG. 13 is a flowchart of a picture process.

FIG. 14 is a flowchart of an MB process.

FIG. 15 is a flowchart of a quantization scale conversion process.

FIG. 16A is an explanatory view of an example of quantization scale conversion.

FIG. 16B is an explanatory view of an example of quantization scale conversion.

FIG. 17 shows an example of conversion of a normal MB in the coding rate conversion apparatus in the first embodiment of the present invention.

FIG. 18 shows an example of conversion of a significant MB in the coding rate conversion apparatus in the first embodiment of the present invention.

FIG. 19A shows an example of quantization matrix conversion in the coding rate conversion apparatus in the first embodiment of the present invention.

FIG. 19B shows an example of quantization matrix conversion in the coding rate conversion apparatus in the first embodiment of the present invention.

FIG. 20A shows a pre-conversion quantization matrix.

FIG. 20B shows converted quantization matrixes according to the process of the first embodiment.

FIG. 20C shows values and processes used for the quantization matrixes.

FIG. 21 is a block diagram showing a structure of a coding rate conversion apparatus 1000A in a second embodiment.

FIG. 22 shows an example of quantization scale conversion in the coding rate conversion apparatus in the second embodiment of the present invention.

FIG. 23 shows an example of conversion of a significant MB in the coding rate conversion apparatus in the second embodiment of the present invention.

FIG. 24A shows an example of quantization matrix conversion in the coding rate conversion apparatus in the second embodiment of the present invention.

FIG. 24B shows an example of quantization matrix conversion in the coding rate conversion apparatus in the second embodiment of the present invention.

FIG. 25A shows a pre-conversion quantization matrix.

FIG. 25B shows converted quantization matrixes according to the process of the second embodiment.

FIG. 25C shows values and processes used for the quantization matrixes.

FIG. 26 is a block diagram showing a structure of a coding rate conversion apparatus 1000B in a third embodiment.

FIG. 27 shows a determination table for determining a quantization matrix conversion method.

FIG. 28A shows an example of quantization matrix conversion in a coding rate conversion apparatus in a fourth embodiment.

FIG. 28B shows an example of quantization matrix conversion in the coding rate conversion apparatus in the fourth embodiment.

FIG. 29A shows an example of quantized DCT coefficient conversion in the coding rate conversion apparatus in the fourth embodiment.

FIG. 29B shows an example of quantized DCT coefficient conversion in the coding rate conversion apparatus in the fourth embodiment.

FIG. 29C shows an example of quantized DCT coefficient conversion in the coding rate conversion apparatus in the fourth embodiment.

FIG. 29D shows an example of quantized DCT coefficient conversion in the coding rate conversion apparatus in the fourth embodiment.

FIG. 30 is a block diagram showing a structure of an example of a stream reception/recording apparatus in a fifth embodiment of the present invention.

FIG. 31 is a block diagram showing a structure of an example of a network distribution system in a sixth embodiment of the present invention.

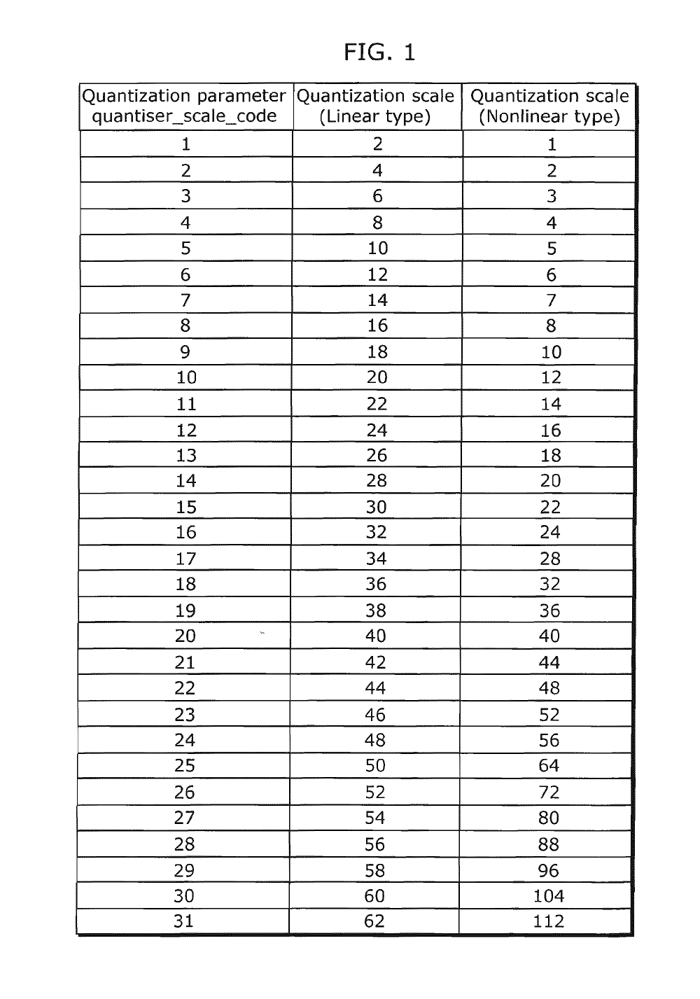

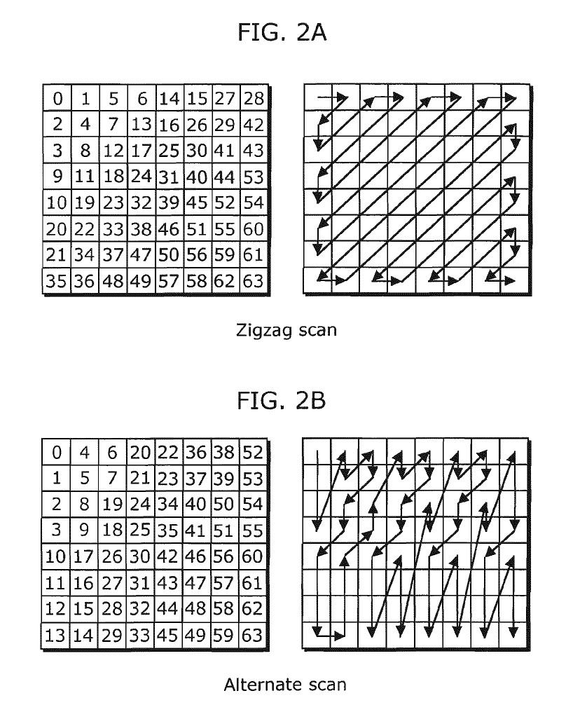

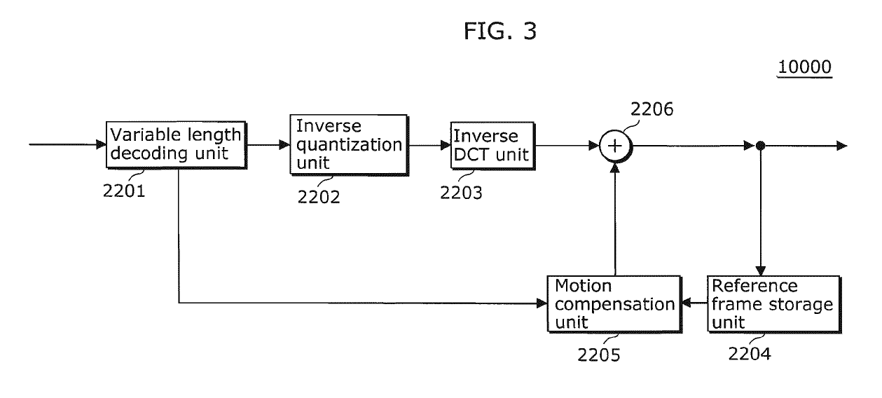

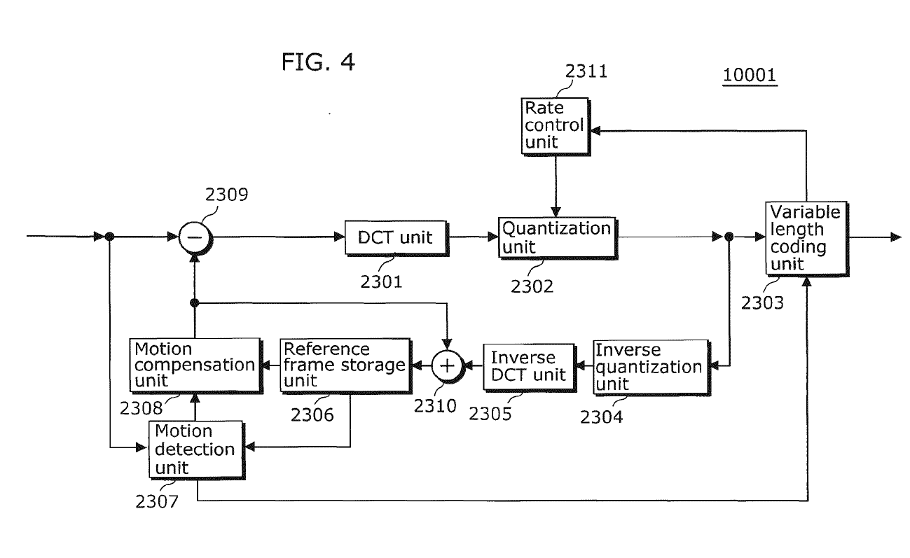

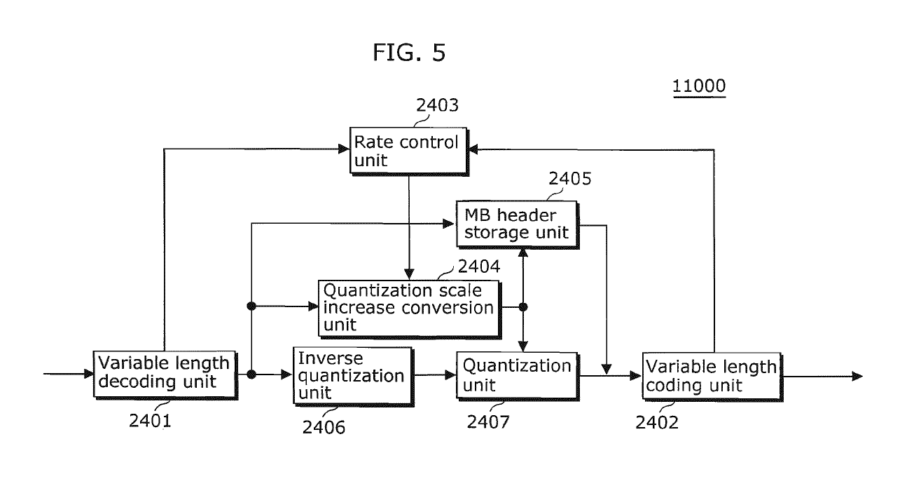

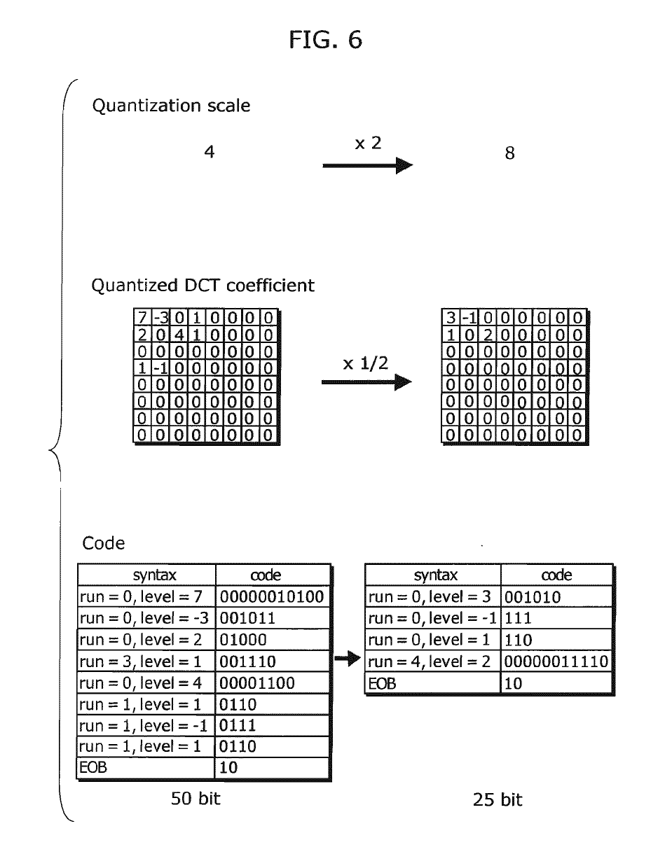

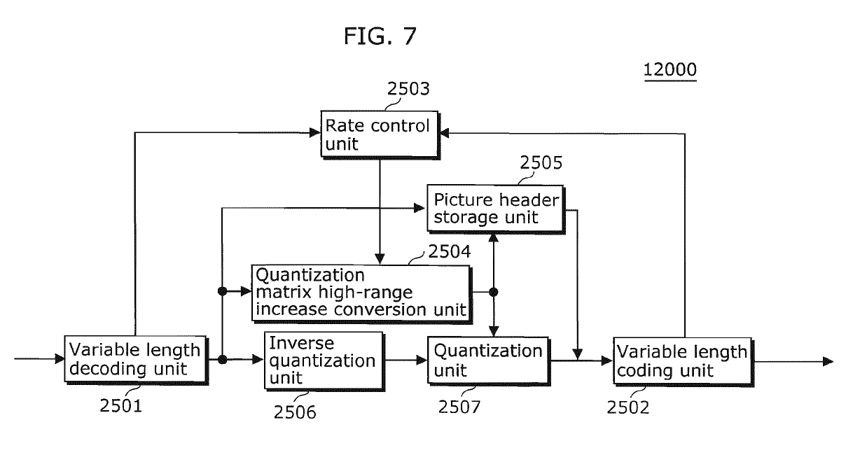

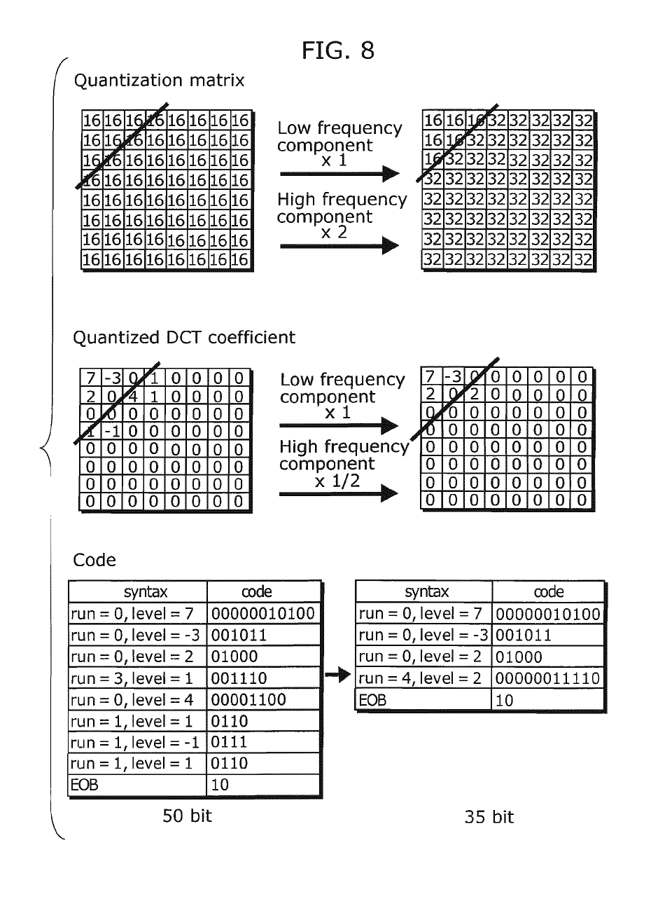

### NUMERICAL REFERENCES

101 Variable length decoding unit
102 Variable length coding unit
103 Rate control unit
104 Quantization scale increase conversion unit
104A Quantization scale increase/decrease conversion unit
105 MB header storage unit
106 Inverse quantization unit
107 Quantization unit
108 Quantization matrix low-range decrease conversion unit
108A Quantization matrix high-range increase conversion unit
109 Picture header storage unit
110, 110A, 110B Quantization matrix conversion control unit
1000, 1000A, 1000B Coding rate conversion apparatus
2008 Broadcast stream reception/recording apparatus
2001, 2101 Coding rate conversion unit
2110 Stream transmission apparatus
2111 Stream reception apparatus
5000 Network distribution system

### BEST MODE FOR CARRYING OUT THE INVENTION

Embodiments of the present invention are described below, with reference to drawings. In the following description, same components are given same reference numerals, and their names and functions are the same. Accordingly, a detailed description of these same components will not be repeated.

### First Embodiment

The following describes an embodiment of the present invention, with reference to drawings.

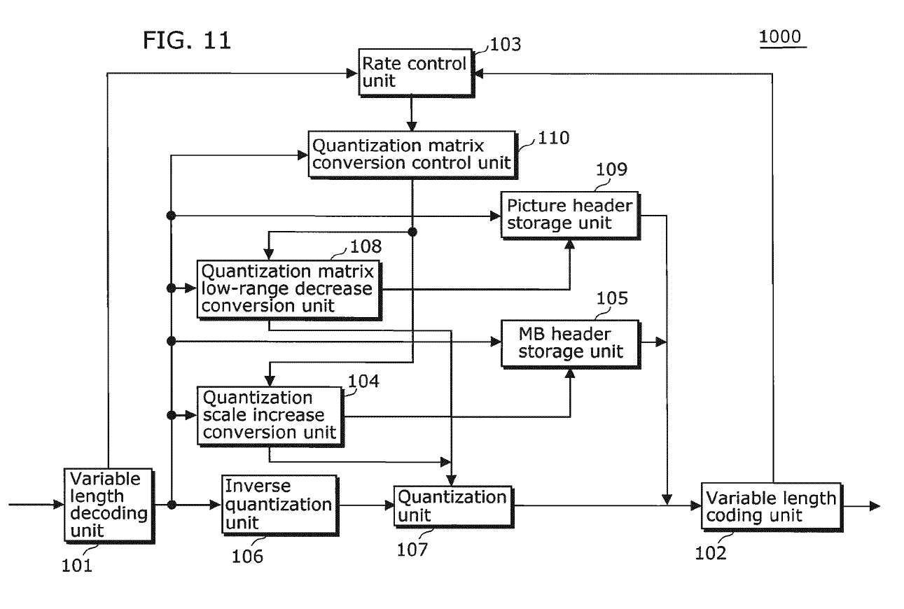

FIG. 11 is a block diagram showing a structure of a coding rate conversion apparatus 1000 in a first embodiment of the present invention.

The coding rate conversion apparatus 1000 includes a variable length decoding unit 101, a variable length coding unit 102, a rate control unit 103, a quantization scale increase conversion unit 104, an MB header storage unit 105, a quantization matrix low-range decrease conversion unit 108, a picture header storage unit 109, and a quantization matrix conversion control unit 110.

The variable length decoding unit 101 receives an input of a stream for restoring a plurality of pictures. Hereafter, the stream inputted in the variable length decoding unit 101 is referred to as an input stream. The input stream is coded data obtained by coding the pictures. The variable length decoding unit 101 decodes an MPEG2 stream as the input stream, and notifies a sequence header and a picture header including a quantization matrix obtained by the decoding, to the picture header storage unit 109. Simultaneously with the notification of the sequence header, the variable length decoding unit 101 notifies the quantization matrix to the quantization matrix low-range decrease conversion unit 108.

The variable length decoding unit 101 also notifies parameters of an MB header unit to the MB header storage unit 105. Simultaneously with the notification of the parameters, the variable length decoding unit 101 converts a quantization scale code (quantization parameter) shown by the MB header unit to a quantization scale, and notifies the obtained quantization scale to the quantization scale increase conversion unit 104 and the quantization matrix conversion control unit 110. The variable length decoding unit 101 further notifies parameters of an MB block unit such as quantized DCT coefficients, to an inverse quantization unit 106.

The inverse quantization unit 106 performs inverse quantization on the quantized DCT coefficients of the MB block unit on the basis of the quantization matrix and the quantization scale of the input stream shown by the notified parameters, thereby calculating DCT coefficients. The inverse quantization unit 106 notifies the calculated DCT coefficients to a quantization unit 107.

The rate control unit 103, when processing a top picture, determines a target code amount of the picture from information such as a picture structure (I, P, B picture) and a coding rate, and notifies the determined target code amount to the quantization matrix conversion control unit 110. The rate control unit 103 also calculates a target quantization scale for each macroblock, and notifies the calculated target quantization scale to the quantization matrix conversion control unit 110.

The quantization matrix conversion control unit 110, when processing the top picture, calculates quantization matrix conversion control information on the basis of the target code amount of the picture and the like. The quantization matrix conversion control unit 110 notifies the calculated conversion control information to the quantization matrix low-range decrease conversion unit 108. The quantization matrix conversion control unit 110 also corrects the target quantization scale for each macroblock on the basis of the quantization matrix control information, and notifies the corrected target quantization scale to the quantization scale increase conversion unit 104.

The quantization matrix low-range decrease conversion unit 108 converts coefficients of low frequency components in the quantization matrix of the input stream in a decreasing direction, on the basis of the quantization matrix conversion control information. The quantization matrix low-range decrease conversion unit 108 simultaneously notifies the converted quantization matrix to the quantization unit 107 and the picture header storage unit 109.

The quantization scale increase conversion unit 104 evaluates significance of each MB with reference to the target quantization scale, and converts the quantization scale of the input stream in an increasing direction to calculate a quantization scale of an output stream. The quantization scale increase conversion unit 104 simultaneously notifies the calculated quantization scale to the quantization unit 107 and the MB header storage unit 105.

The picture header storage unit 109 stores the sequence header and the picture header notified from the variable length decoding unit 101, in an internal buffer (not illustrated). The picture header storage unit 109 rewrites the data in the internal buffer when requested by the quantization matrix low-range decrease conversion unit 108. The picture header storage unit 109 then notifies the sequence header and the picture header stored in the buffer, to the variable length coding unit 102.

The MB header storage unit 105 stores the MB header notified from the variable length decoding unit 101, in an internal buffer (not illustrated). The MB header storage unit 105 converts the quantization scale to a quantization scale code and rewrites the data in the buffer to the new value, when requested by the quantization scale increase conversion unit 104. The MB header storage unit 105 then notifies the MB header stored in the internal buffer, to the variable length coding unit 102.

The quantization unit 107 performs requantization on the DCT coefficients calculated as a result of the inverse quantization performed by the inverse quantization unit 106, according to the quantization matrix calculated by the quantization matrix low-range decrease conversion unit 108 and the quantization scale calculated by the quantization scale increase conversion unit 104. The quantization unit 107 stores quantized DCT coefficients obtained by the requantization, in an internal coefficient buffer (not illustrated) in the quantization unit 107. The quantization unit 107 further notifies the obtained quantized DCT coefficients to the variable length coding unit 102.

The variable length coding unit 102 codes the sequence header and the picture header including the quantization matrix notified from the picture header storage unit 109. The variable length coding unit 102 also codes the information shown by the MB header unit notified from the MB header storage unit 105. The variable length coding unit 102 further codes the quantized DCT coefficients of the MB block unit received from the quantization unit 107. The variable length coding unit 102 generates an MPEG2 stream (hereafter referred to as an output stream) from the data obtained as a result of the above coding.

The following describes a process (hereafter referred to as a coding rate conversion process) performed by the coding rate conversion apparatus 1000 in the first embodiment of the present invention. Note that the coding rate conversion process according to the present invention is a process for reducing a coding rate of the coded data as the input stream. That is, the coding rate of the coded data after the coding rate conversion process is lower than the coding rate of the coded data before the coding rate conversion process.

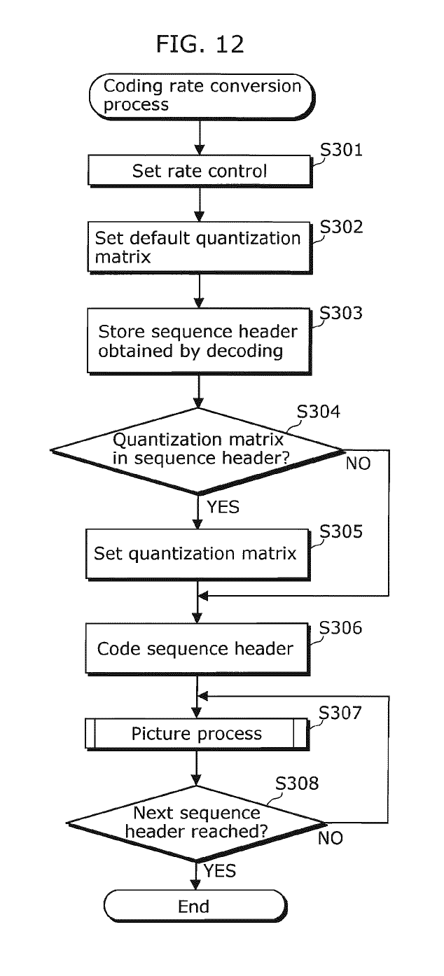

FIG. 12 is a flowchart of the coding rate conversion process.

First, the rate control unit 103 is set so as to be in a state of being capable of target bit calculation in the coding rate conversion process, according to need (Step S301). Next, in case no quantization matrix is coded in the input stream, the variable length decoding unit 101 sets a default quantization matrix defined in MPEG2 as a quantization matrix used by the quantization matrix low-range decrease conversion unit 108, before decoding a sequence header in the stream (Step S302).

The variable length decoding unit 101 then stores the sequence header obtained by decoding the input stream, in the internal buffer (not illustrated) in the picture header storage unit 109 (Step 5303).

When a quantization matrix is included in the sequence header obtained by the decoding (Step S304: YES), the variable length decoding unit 101 sets this quantization matrix as the quantization matrix used by the quantization matrix low-range decrease conversion unit 108 (Step S305). In this case, the quantization matrix in the sequence header is written over the default quantization matrix set in Step S302.

When no quantization matrix is included in the sequence header (Step S304: NO), the default quantization matrix set in Step S302 is directly put to use.

Next, the variable length coding unit 102 codes the information of the sequence header stored in the picture header storage unit 109 (Step S306). After this, a picture process is performed (Step S307). The picture process is a process in units of pictures. The picture process is repeatedly performed (Step S308: NO) until a next sequence header in the stream is reached (Step S308: YES).

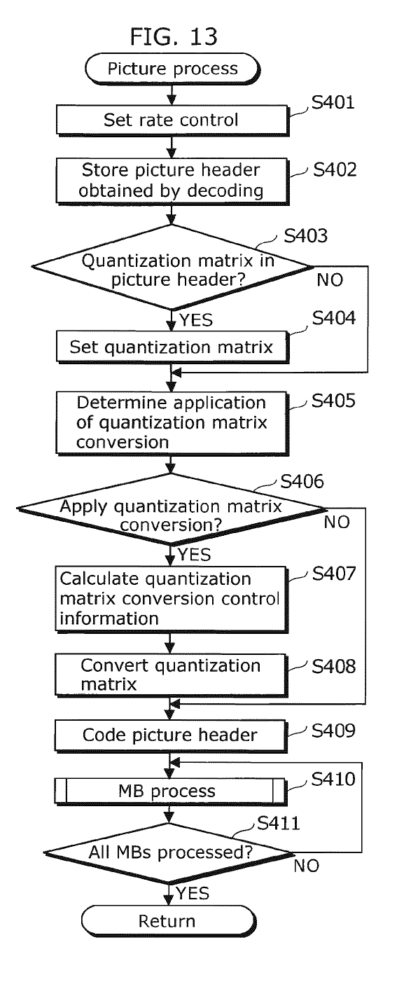

FIG. 13 is a flowchart of the picture process.

First, the rate control unit 103 is set according to need, to calculate a target bit amount in a processing object picture in the picture process (Step S401).

Next, the variable length decoding unit 101 stores a picture header obtained by decoding the input stream, in the internal buffer (not illustrated) in the picture header storage unit 109 (Step S402).

When a quantization matrix is included in the picture header obtained by the decoding (Step S403: YES), the variable length decoding unit 101 sets this quantization matrix as the quantization matrix used by the quantization matrix low-range decrease conversion unit 108 (Step S404). When no quantization matrix is included in the picture header obtained by the decoding (Step S403: NO), the quantization matrix set by the coding rate conversion process is directly put to use by the quantization matrix low-range decrease conversion unit 108.

Following this, the quantization matrix conversion control unit 110 determines whether or not to apply quantization matrix conversion to the processing object picture, on the basis of a target code amount and the like obtained from the rate control unit 103 (Step S405).

When applying the quantization matrix conversion (Step S406: YES), the quantization matrix conversion control unit 110 calculates quantization matrix conversion control information on the basis of the target code amount and the like obtained from the rate control unit 103 (Step S407). The quantization matrix low-range decrease conversion unit 108 converts coefficients of low frequency components in the quantization matrix set in any of Steps S302, S305, and S404 in a decreasing direction or an increasing direction, on the basis of the quantization matrix conversion control information (Step S408). This will be described in detail later.

The quantization matrix low-range decrease conversion unit 108 stores the converted quantization matrix in the picture header storage unit 109. The variable length coding unit 102 codes the picture header stored in the picture header storage unit 109 (Step S409).

After this, an MB process is performed (Step S410). The MB process is a process in units of macroblocks. The number of macroblocks corresponding to the processing object picture can be calculated using the information shown by the picture header. The MB process is performed on all macroblocks corresponding to the processing object picture. After the MB process is performed on all macroblocks (Step S411: YES), this picture process ends, and the operation returns to the coding rate conversion process in FIG. 12 where Step S308 is performed again.

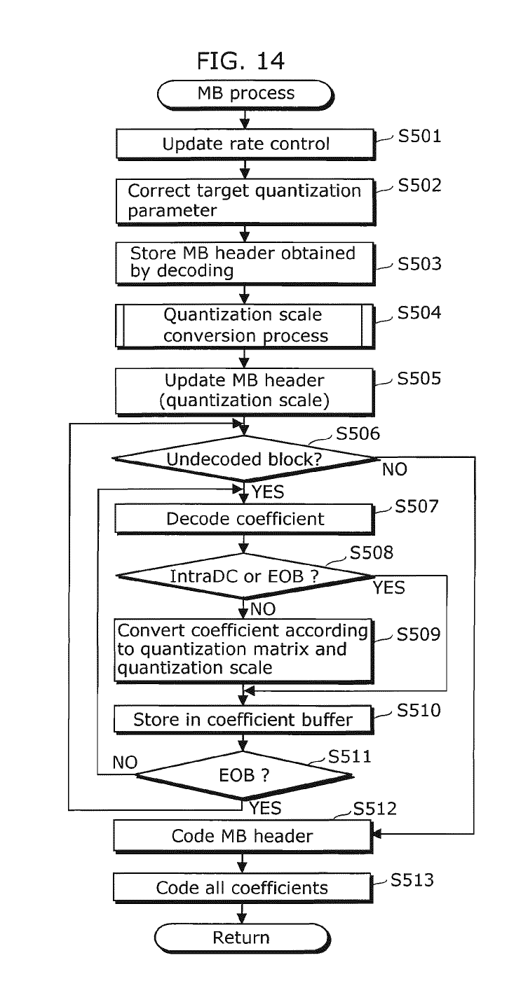

FIG. 14 is a flowchart of the MB process.

First, the rate control unit 103 updates a state of a virtual buffer which is used as a reference of rate control, according to the target bit amount in the processing object picture calculated in Step S401 and a conversion achieved value of the processing object picture, and calculates a target quantization scale of a processing object macroblock (Step S501).

Next, the quantization matrix conversion control unit 110 corrects the target quantization scale on the basis of the quantization matrix conversion control information calculated in Step S407 (Step S502). The quantization matrix conversion control unit 110 notifies the corrected target quantization scale to the quantization scale increase conversion unit 104.

Following this, the variable length decoding unit 101 stores information shown by an MB header unit of the processing object MB obtained by decoding the input stream, in the internal buffer (not illustrated) in the MB header storage unit 105 (Step S503). The variable length decoding unit 101 also notifies the information shown by the MB header unit of the processing object MB obtained by the decoding, to the quantization matrix conversion control unit 110. The information shown by the MB header unit of the processing object MB is a quantization scale code of the MB.

After this, a quantization scale conversion process is performed (Step S504).

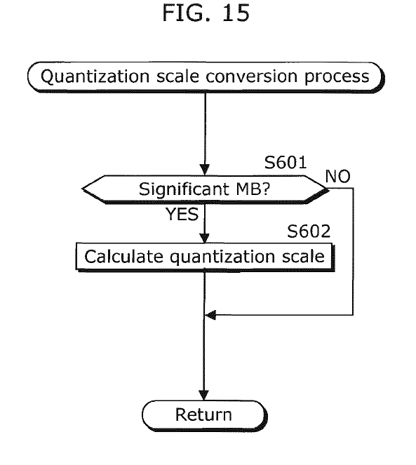

FIG. 15 is a flowchart of the quantization scale conversion process.

First, the quantization matrix conversion control unit 110 determines whether or not there is a significant MB (Step S601). For instance, it is assumed here that the significant MB is a macroblock which shows an image of a resolution higher than a predetermined resolution as a result of being decoded. Which is to say, the significant MB is such that an image (hereafter referred to as a decoded block image) obtained by decoding the significant MB shows a high-resolution image. In other words, the significant MB is such that the decoded block image obtained by decoding the significant MB shows an image of a frequency component higher than a predetermined frequency.

As an example, it is assumed here that the significant MB is such an MB where a result of multiplying a data amount of an MB block unit of the MB and a quantization scale obtained by converting a quantization scale code shown by an MB header unit of the MB exceeds a predetermined value. Hereafter, an MB other than the significant MB is referred to as a normal MB.

When the processing object MB is the significant MB, the quantization matrix conversion control unit 110 determines that there is the significant MB (Step S601: YES). When the processing object MB is the significant MB, the quantization matrix conversion control unit 110 notifies the quantization scale increase conversion unit 104 that the processing object MB is the significant MB. When the processing object MB is the normal MB, on the other hand, the quantization matrix conversion control unit 110 determines that there is no significant MB (Step S601: NO).

When the quantization matrix conversion control unit 110 determines that there is the significant MB, the quantization scale increase conversion unit 104 calculates a quantization scale by multiplying the notified target quantization scale by a value (for example, a value equal to or smaller than 1) (Step S602). This completes the quantization scale conversion process, and the operation returns to the MB process in FIG. 14 where Step S505 is performed.

In Step S505, when the quantization matrix conversion control unit 110 determines that there is the significant MB, the quantization scale increase conversion unit 104 converts the calculated quantization scale to a quantization scale code, and replaces the quantization scale code shown by the MB header unit of the processing object MB stored in the MB header storage unit 105, with the converted quantization scale code.

In Step S505, when the quantization matrix conversion control unit 110 determines that there is no significant MB, the quantization scale increase conversion unit 104 converts the notified target quantization scale to a quantization scale code, and replaces the quantization scale code shown by the MB header unit of the processing object MB stored in the MB header storage unit 105, with the converted quantization scale code.

This completes a process of updating the information shown by the MB header unit, and the operation moves to a process of conversing quantized DCT coefficients.

First, it is determined whether or not any of a plurality of coded MBs has not been decoded yet (Step S506). Which is to say, it is determined whether or not all MBs of the picture corresponding to the processing object MB have been decoded. When there is an MB which has not been decoded yet (Step S506: YES), the variable length decoding unit 101 decodes a plurality of quantized DCT coefficients shown by the coded processing object MB in a predetermined order, one at a time in Step S507 (Step S507).

In MPEG2, a DC coefficient of an Intra MB is quantized independently of a quantization scale. This being so, the DC coefficient is excluded from conversion in this embodiment. When a processing object quantized DCT coefficient is not a DC coefficient of an Intra MB or a block termination EOB (End Of Block) is not reached yet (Step S508: NO), the inverse quantization unit 106 inverse quantizes the decoded processing object quantized DCT coefficient, using the quantization matrix and the quantization scale corresponding to the processing object MB shown in the input stream.

After this, the quantization unit 107 requantizes the DCT coefficient calculated by the inverse quantization, using the quantization matrix calculated in Step S408 and the quantization scale calculated in Step S602 or the target quantization scale. Thus, the quantization unit 107 obtains a quantized DCT coefficient. This completes the conversion (Step S509).

The quantization unit 107 stores the obtained quantized DCT coefficient in the internal coefficient buffer (not illustrated) in the quantization unit 107 (Step S510). This process is repeated until the block termination EOB is reached, as a result of which the decoding of the processing object MB is completed (Step S511).

Further, when the decoding is completed for all coded MBs (Step S506: NO), the whole MB information decoding is completed.

Lastly, the variable length coding unit 102 codes all macroblock headers stored in the MB header storage unit 105 (Step S512). The variable length coding unit 102 also codes all quantized DCT coefficients stored in the internal coefficient buffer (not illustrated) in the quantization unit 107 (Step S513). As a result, the MB process is completed. The operation then returns to the picture process in FIG. 13 where Step S411 is performed again.

By performing the coding rate conversion process in FIG. 12, the picture process in FIG. 13, the MB process in FIG. 14, and the quantization scale conversion process in FIG. 15 described above, a decoding process, an inverse quantization process, a quantization process, and a coding process of the coded data are carried out. These processes allow the output stream (coded data) to be generated from the input stream. The coding rate of the coded data generated as the output stream is lower than the coding rate of the coded data as the input stream.

The following describes a specific operation of rate control in the coding rate conversion apparatus 1000 in the first embodiment of the present invention. When processing the top picture included in the input stream, target code amount T(i) of the picture is allocated first. Target code amount T(i) can be calculated in accordance with Step 1 of TM5 mentioned earlier, and so its detailed description is omitted here. Furthermore, the target quantization scale needs to be calculated for each macroblock. The target quantization scale can be calculated in accordance with Step 2 of TM5, and so its detailed description is omitted here.

Though TM5 is mentioned here as a rate control method, other rate control methods are also applicable. The present invention is not dependent on a specific rate control method.

The following describes a specific process of quantization matrix conversion of Step S408 in FIG. 13 performed by the coding rate conversion apparatus 1000 in the first embodiment of the present invention.

Suppose there are the i-th picture and a picture (hereafter referred to as an evaluation object picture) immediately preceding the i-th picture. In this case, the evaluation object picture is the (i−1)-th picture. It is assumed here that the evaluation object picture is a picture to be displayed before the i-th picture, and the i-th picture and the evaluation object picture are pictures of a same type.

In addition, suppose a quantization matrix conversion factor of low frequency components is α(i−1) (where α(i−1)<1), and a quantization scale conversion factor mean value is β(i−1). A quantization matrix conversion factor is a value for converting coefficients of a quantization matrix. A quantization scale conversion factor is a value for converting a quantization scale. This being the case, quantized DCT coefficient conversion factor γ(i−1) (mean value of low frequency components) can be calculated according to an expression γ(i−1)=α(i−1)×β(i−1).

In the above expression, when γ=1, quantization errors in low frequency components of DCT coefficients are smallest. Furthermore, when γ is reasonably small (denoted by γmax here) even though larger than 1, image quality degradation of low frequency components can be considered to be within a permissible range. In the case where quantization errors are expected to exceed the permissible range, such control that restricts quantization errors within the permissible range is necessary. On the other hand, when γ is smaller than 1, image quality degradation of low frequency components does not occur, but the code amount increases, so that control of making γ equal to or larger than 1 is necessary.

Assume the evaluation object picture (the (i−1)-th picture) located closest to the i-th picture has a quantization scale of a same tendency as the i-th picture (β(i)=β(i−1)). In this case, quantization matrix conversion factor α(i) of the i-th picture can be calculated according to the following expression.

$$a ( i ) = 1 \times a ( i - 1 ) / γ ( i - 1 ) ( where γ ( i - 1 ) < 1 ) a ( i - 1 ) ( where 1 \leq γ ( i - 1 ) \leq γ max ) γ max \times a ( i - 1 ) / γ ( i - 1 ) ( where γ max < γ ( i - 1 ) ) .$$

Next, the quantization matrix of the input stream is converted to quantization matrix Wo(u, v) of the output stream according to the following expression (hereafter referred to as matrix conversion expression A), using quantization matrix conversion factor α(i).

$$\begin{matrix}Wo ( u , v ) = a ( i ) \times Wi ( u , v ) \\ ( where u + v \leq ɛ ( low frequency component ) ) \\ = Wi ( u , v ) \\ ( where u + v > ɛ ( high frequency component ) ) .\end{matrix}$$

Here, Wi(u, v) is a constant showing the (u, v)-th coefficient (u=0 to 7, v=0 to 7) of the quantization matrix of the input stream. Wo(u, v) is a constant showing the (u, v)-th coefficient of the quantization matrix of the output stream. Wo(u, v) also shows the coefficient specified by row (v+1) and column (u+1). For instance, when u=2 and v=5, Wo(u, v) shows the coefficient specified by row 6 and column 3. ε is a constant showing a frequency threshold (reference frequency) for suppressing errors.

Though the closest picture of the same picture type (evaluation object picture) is selected here as a quantization scale achieved value, the present invention is not limited to this. For example, the evaluation object picture may be selected irrespective of the type of the i-th picture.

Moreover, a picture not closest to the i-th picture may instead be selected. Further, not a single picture but a plurality of pictures preceding the i-th picture may be selected. As an alternative, a quantization scale calculated by pre-reading the quantization scale of the i-th picture may be used instead of the quantization scale of the picture preceding the i-th picture. The quantization scale may be predicted according to other methods.

In this example, the quantization scale conversion factor mean value is used in the calculation of the quantization matrix conversion factor. However, the present invention is not limited to this. Other achieved values relating to the quantization scale such as a quantization scale conversion factor minimum value, or a fixed value and the like may be used. Moreover, the calculation method of the quantization matrix conversion factor may be irrelevant to the quantization scale.

The following describes a specific process of quantization scale conversion (quantization scale conversion process in FIG. 15) performed by the coding rate conversion apparatus 1000 in the first embodiment of the present invention.

The target quantization scale obtained by the rate control is based on Step 2 of TM5, and is determined irrespective of the quantization matrix. Therefore, in the coding rate conversion apparatus 1000 that converts the quantization matrix, there is a possibility that the quantization scale used is not an optimum quantization scale. In view of this, the target quantization scale may be corrected using the above quantization matrix conversion factor and the like.

For instance, in the case where quantization matrix conversion factor α of low frequency components is smaller than 1, the code amount of the coded data is in an increasing direction when compared with the case of not converting the quantization matrix. This being so, when the quantization scale obtained by the rate control is directly used, the code amount of the coded data may not be able to be reduced sufficiently. In such a case, the target quantization scale may be corrected to be slightly larger so that the code amount of the coded data can be reduced.

As an example, target quantization scale mq(j) obtained by the rate control may be corrected to

mq′(j)=mq(j)×(1/α).

Though the target quantization scale is corrected by multiplying by 1/α in this example, the code amount of the coded data can also be reduced with a value, other than 1/α, which is larger than 1. Moreover, the target quantization scale may be corrected according to other expressions, or the correction may not be performed.

Next, the quantization scale of the macroblock is actually calculated.

Quantization scale qo(j) of the output stream can be derived according to a technique disclosed in Japanese Unexamined Patent Application Publication No. 2001-204028 of Patent Reference 2 as a conventional technique, and so its detailed description is omitted here.

$$qo ( j ) = qi ( j ) ( where mq ( j ) < 1.5 \times qi ( j ) ) 2 \times qi ( j ) ( where 1.5 \times qi ( j ) \leq mq ( j ) < 2 \times qi ( j ) ) mq ( j ) ( where 2 \times qi ( j ) < mq ( j ) ) .$$

Here, qi(j) is the quantization scale of the input stream, and mq(j) is the target quantization scale.

Though quantization scale qo(j) is derived according to the above expression in this example, quantization scale qo(j) may be derived according to other expressions.

As noted earlier, when “(quantized DCT coefficient conversion factor (low frequency component) γ)=(quantization matrix conversion factor (low frequency component) α)×(quantization scale conversion factor β(β=qo(j)/qi(j)))” is smaller than 1, there is no increase in quantization errors in low frequency components of DCT coefficients, but the code amount of the coded data increases.

Since coding rate conversion is intended for a reduction in coding rate of coded data, conversion which causes a code amount increase even in one part of MBs has poor conversion efficiency. Accordingly, a method of controlling the quantization scale of the output stream by limiting it within a range that does not cause a code amount increase may be adopted.

Quantization scale qo′(j) in this case can be calculated according to the following expression.

$${qo}^{′} ( j ) = 1 / a \times qi ( j ) ( where mq ( j ) < 1.5 \times qi ( j ) ) max \{ 1 / a , 2 \} \times qi ( j ) \} ( where 1.5 \times qi ( j ) \leq mq ( j ) < 2 \times qi ( j ) ) max \{ 1 / a \times qi ( j ) , mq ( j ) \} ( where 2 \times qi ( j ) mq ( j ) ) .$$

By using quantization scale qo'(j) calculated according to the above expression, it is possible to perform such conversion that suppresses quantization errors in low frequency components of DCT coefficients.

Though the code amount increase of the coded data is suppressed by multiplying by 1% in this example, the value used here may not necessarily be 1/α. A value larger than 1/α enables the conversion to be performed without causing the code amount increase of the coded data.

In the aforementioned significant MB, however, overall image quality degradation can be suppressed more by suppressing quantization errors in not only low frequency components but also high frequency components of DCT coefficients. Therefore, in the significant MB, it is desirable to set such a quantization scale that can suppress quantization errors in all frequency domains.

For instance, the significant MB is a macroblock that shows an image of a resolution higher than a predetermined resolution as a result of being decoded, as mentioned earlier. As an example, it is assumed here that the significant MB is such that a result of multiplying a data amount of an MB block unit of the MB and a quantization scale obtained by converting a quantization scale code shown by an MB header unit of the MB exceeds a predetermined value.

Quantization scale qo″(j) corresponding to the significant MB can be calculated according to the following expression.

qo″(j)=qi(j).

By using quantization scale qo″(j) for the significant MB, such conversion that suppresses quantization errors in all frequency domains can be achieved.

For the MB (normal MB) other than the significant MB, qo′(j) mentioned above can be used as the quantization scale.

Note that the significant MB may be determined using the calculation other than the above calculation ((MB block unit data amount)×(quantization scale)).

The following describes an example of quantization scale conversion.

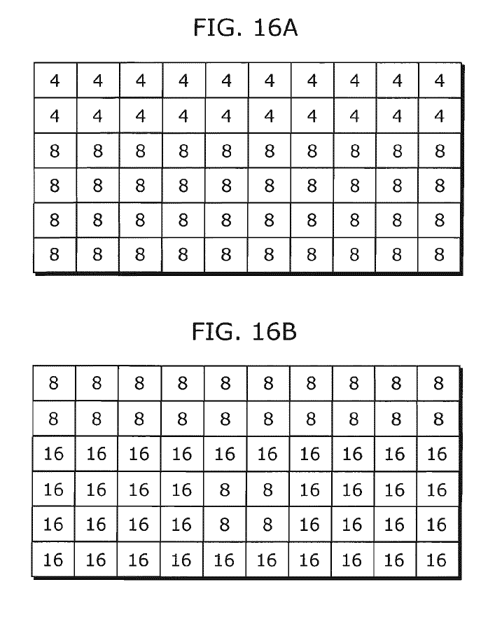

FIGS. 16A and 16B are explanatory views of an example of quantization scale conversion. FIG. 16A shows an example of quantization scales. A plurality of numbers shown in FIG. 16A represent quantization scales which are each set for a different one of a plurality of MBs constituting coded data of a picture.

Suppose a quantization scale set for each of MBs corresponding to an upper part of the picture obtained by decoding the coded data is “4”, and a quantization scale set for each of MBs corresponding to center and lower parts of the picture obtained from the coded data is “8”, as shown in FIG. 16A.

It is assumed here that the quantization scale mean value at the time of rate control based on the target coding rate is “8”. In the case of converting the quantization scale on the basis of the quantization scale mean value, the quantization scale set for each of the MBs corresponding to the upper part of the picture is converted from “4” to “8”, and the quantization scale set for each of the other MBs is held at “8”.

In the case of applying the above expression of quantization scale qo′(j) formulated in consideration of the coding efficiency of quantization matrix conversion, however, when quantization matrix conversion factor α=½, quantization scale conversion factor β≧2 is necessary in order to maintain or reduce the coding rate of the coded data. Accordingly, the quantization scale set for each of the MBs corresponding to the center and lower parts of the picture is converted from “8” to “16”, as shown in FIG. 16B.

On the other hand, quantization scale conversion factor β set for the aforementioned significant MB among the MBs corresponding to the center and lower parts of the picture is “1”, and therefore the quantization scale is held at “8”.

Meanwhile, the quantization scale set for each of the MBs corresponding to the upper part of the picture is converted from “4” to “8”, as shown in FIG. 16B.

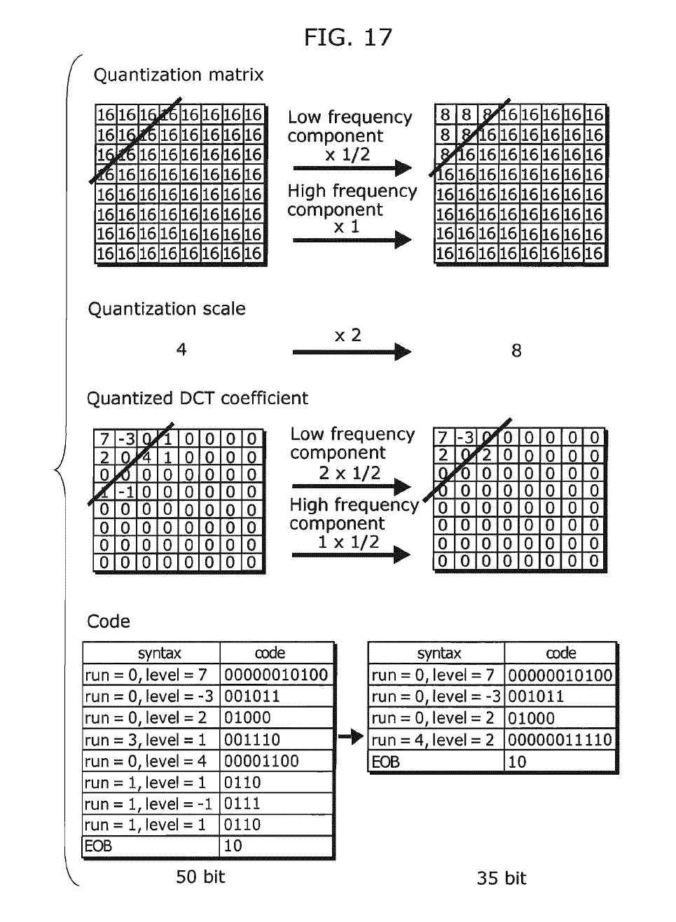

The following describes a specific process of quantization of a normal MB performed by the quantization unit 107 in the coding rate conversion apparatus 1000 in the first embodiment of the present invention, with reference to FIG. 17. The specific process of quantization of a normal MB is performed in Step S509 in FIG. 14.

Suppose coefficients of low frequency components in the quantization matrix (where ε=2) are converted by ½ times as a result of rate control and quantization matrix conversion. That is, quantization matrix conversion factor α of low frequency components is “½”. On the other hand, quantization matrix conversion factor α of high frequency components is “1”. Moreover, suppose the quantization scale is increased from “4” to “8”, that is, increased by 2 times, as a result of rate control and quantization scale conversion. That is, quantization scale conversion factor β is “2”. It is assumed that the value “8” of the quantization scale in this case is the aforementioned target quantization scale.

Let ε=2 in matrix conversion expression A mentioned above. This being the case, six coefficients located in a top left triangle out of 64 coefficients shown by the quantization matrix are coefficients of low frequency components in the quantization matrix, and coefficients other than the six coefficients located in the top left triangle out of the 64 coefficients shown by the quantization matrix are coefficients of high frequency components in the quantization matrix.

The left quantization matrix of the two quantization matrixes shown in FIG. 17 is a quantization matrix before conversion (hereafter referred to as a pre-conversion quantization matrix). The right quantization matrix of the two quantization matrixes shown in FIG. 17 is a quantization matrix after conversion (hereafter referred to as a converted quantization matrix).

The converted quantization matrix in FIG. 17 is a matrix obtained by the quantization matrix low-range decrease conversion unit 108 converting the pre-conversion quantization matrix using quantization matrix conversion factor α “½” of low frequency components, in Step S408 in FIG. 13.

In the converted quantization matrix in FIG. 17, the coefficients of the high frequency components are unchanged, while the coefficients of the low frequency components become smaller (½ times). Accordingly, when quantization is performed using the converted quantization matrix in FIG. 17, the code amount (coding rate) of the coded data increases. Which is to say, the converted quantization matrix in FIG. 17 is a matrix for increasing the code amount (coding rate) of the coded data.

The left matrix of the two matrixes showing quantized DCT coefficients in FIG. 17 is a matrix before quantization (hereafter referred to as a pre-requantization matrix). That is, the pre-requantization matrix shown in FIG. 17 is a matrix obtained as a result of inverse quantization by the inverse quantization unit 106. The right matrix of the two matrixes showing quantized DCT coefficients in FIG. 17 is a matrix obtained by requantization (hereafter referred to as a requantized matrix).

The requantized matrix in FIG. 17 is a matrix obtained by the quantization unit 107 requantizing the pre-requantization matrix using the converted quantization matrix in FIG. 17 and the calculated quantization scale “8”, in Step S509 in FIG. 14.

With reference to the above inverse quantization expressions, quantized DCT coefficients need to be approximately in inverse proportion to the quantization matrix and the quantization scale. To do so, quantized DCT coefficients of low frequency components need to be converted by 2 (1/α)×½ (1/β)=1 times, and quantized DCT coefficients of high frequency components need to be converted by 1 (1/α)×½ (1/β)=½ times.

Consider the case of converting the pre-requantization matrix in FIG. 17 which is a block of an Inter MB where a total of eight nonzero quantized DCT coefficients 7, —3, 2, 1, 4, 1, —1, and 1 are present and the first three coefficients (7, −3, 2) out of the eight nonzero quantized DCT coefficients correspond to low frequency components.

In this case, the quantized DCT coefficients of the low frequency components need not be converted, as shown by the requantized matrix in FIG. 17. The quantized DCT coefficients of the high frequency components are converted to 0, 2, 0, 0, and 0 obtained by converting 0.5, 2, 0.5, −0.5, and 0.5 to integers, as shown by the requantized matrix in FIG. 17.

Thus, the code amount which is 50 bits at the time of input can be reduced to 35 bits. In this way, the coding rate of the coded data can be reduced without causing quantization errors in low frequency components.

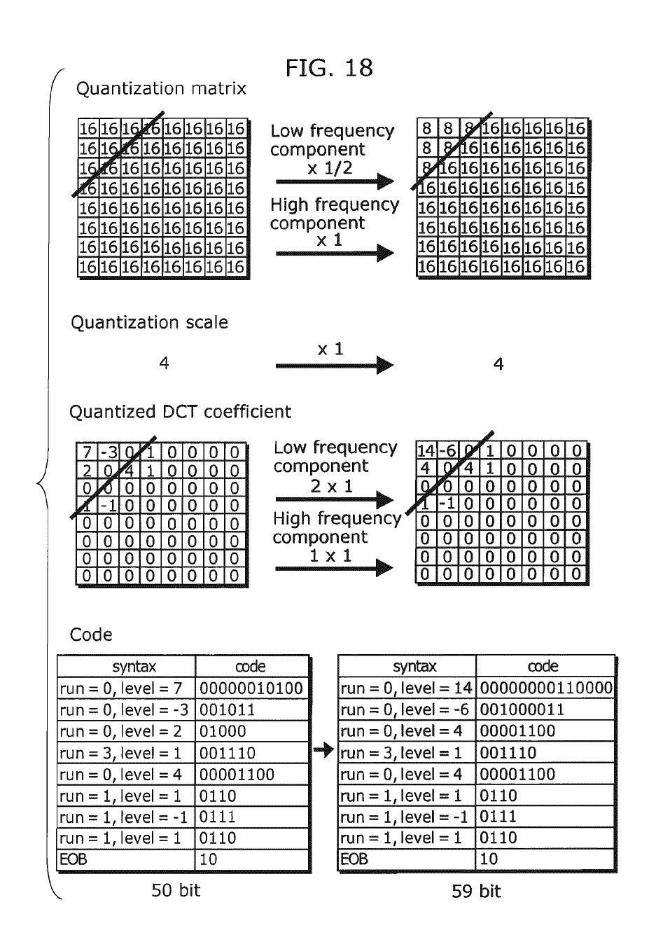

The following describes a specific process of quantization of a significant MB performed by the quantization unit 107 in the coding rate conversion apparatus 1000 in the first embodiment of the present invention, with reference to FIG. 18. The specific process of quantization of a significant MB is performed in Step S509 in FIG. 14.

In the normal MB shown in FIG. 17, the quantization scale is converted by 2 times, so that quantization errors occur in high frequency components. In the significant MB, on the other hand, the quantization scale is set by 1 times in order to suppress quantization errors in high frequency components, too. That is, quantization scale conversion factor β is “1”. In this case, the quantization scale is calculated in Step S602 in FIG. 16. As a result, the quantization scale “4” is calculated.

FIG. 18 shows a pre-conversion quantization matrix, a converted quantization matrix, a pre-requantization matrix, and a requantized matrix, as in FIG. 17. Since the converted quantization matrix in FIG. 18 is the same as the converted quantization matrix in FIG. 17, its detailed description is not repeated here.

The requantized matrix in FIG. 18 is a matrix obtained by the quantization unit 107 requantizing the pre-requantization matrix in FIG. 18 using the converted quantization matrix in FIG. 18 and the calculated quantization scale “4”, in Step S509 in FIG. 14.

With reference to the above inverse quantization expressions, quantized DCT coefficients need to be approximately in inverse proportion to the quantization matrix and the quantization scale. To do so, quantized DCT coefficients of low frequency components need to be converted by 2 (1/α)×1(1/β)=2 times, and quantized DCT coefficients of high frequency components need to be converted by 1 (1/α)×1(1/β)=1 times.

Consider the case of converting the pre-requantization matrix in FIG. 18 which is a block of an Inter MB where a total of eight nonzero quantized DCT coefficients 7, —3, 2, 1, 4, 1, —1, and 1 are present and the first three coefficients (7, −3, 2) out of the eight nonzero quantized DCT coefficients correspond to low frequency components.

In this case, the quantized DCT coefficients of the low frequency components are converted to 14, −6, and 4 by 2 times from the input, as shown by the requantized matrix in FIG. 18. The quantized DCT coefficients of the high frequency components need not be converted from the input, as shown by the requantized matrix in FIG. 18.

The quantized DCT coefficients of the low frequency components are integers as long as their conversion factor is an integer, and therefore no quantization errors newly occur. The quantized DCT coefficients of the high frequency components need not be converted, and so quantization errors do not occur.

Thus, though the code amount which is 50 bits at the time of input increases to 59 bits, the conversion can be performed with there being no quantization errors in all frequencies from low frequency components to high frequency components.

When many significant MBs are included in all MBs corresponding to a picture, the above code amount increase presents a serious obstacle to achieving the target rate. However, when the number of significant MBs in all MBs corresponding to the picture is sufficiently small, it is possible to make up for the above code amount increase by reducing the code amount of the other normal MBs.

Accordingly, in the coding rate conversion apparatus 1000 in the first embodiment of the present invention, by making coefficients of low frequency components of the quantization matrix smaller than their input values as a whole, the occurrence of quantization errors in low frequency components can be suppressed, and also the occurrence of quantization errors in high frequency components in significant MBs can be suppressed.

In other words, according to the process of this embodiment, it is possible to suppress image quality degradation caused by quantization errors in low frequency components, and further suppress image quality degradation caused by quantization errors in high frequency components in a specific macroblock as a significant MB.

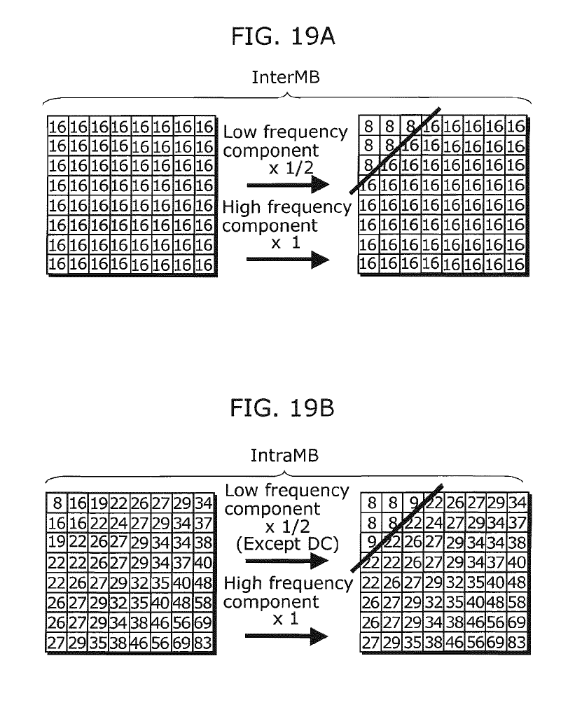

This embodiment describes the case where the type of macroblock is an Inter MB and all coefficients of the quantization matrix are constant, as shown in FIG. 19A. However, the present invention is not limited to this. The process of this embodiment is equally applicable to the case where the type of macroblock is an Intra MB or the coefficients of the quantization matrix are not constant but are varied, as shown in FIG. 19B.

Moreover, the rate conversion using the quantization matrix may be applied to only one of the Inter MB and the Intra MB, or the conversion factor of the quantization matrix and the like may be changed in both the Inter MB and the Intra MB.

This embodiment describes the case where no conversion errors occur in the coefficients of the quantization matrix, as shown in FIG. 19A. However, conversion errors may occur in the coefficients of the quantization matrix, as shown in FIG. 19B.

The present invention is described on the basis of MPEG2, but the present invention is not limited to MPEG2, and is applicable to any codec which designates the quantization matrix in units of pictures and the quantization parameter in units of macroblocks, such as JPEG, MPEG1, MPEG4, H.264, and so on.

The present invention is described on the basis of a DCT, but other conversion methods may instead be used so long as they are orthogonal transforms that can decompose image data into frequency components.

There is a situation when, as in the present invention, special quantization or coding is conducted in some codecs where a DC component and the like, such as a DC component of an Intra MB of MPEG2, is excluded from the application of the quantization scale. These special coefficients may not excluded from the quantization matrix conversion in the present invention, as shown in FIG. 19B.

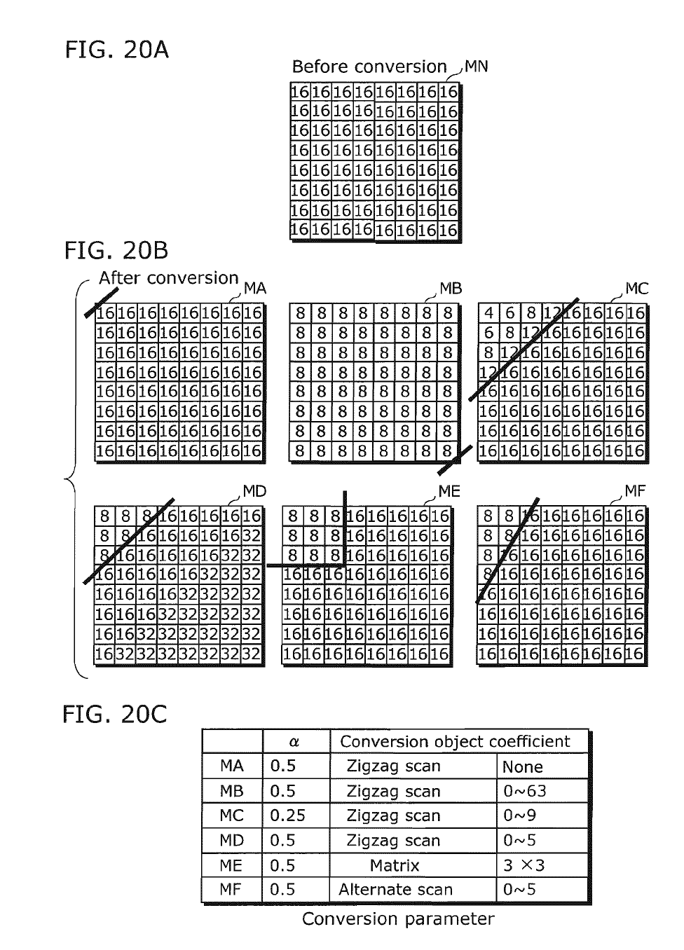

FIG. 20A shows a pre-conversion quantization matrix. FIG. 20B shows converted quantization matrixes according to the process of the first embodiment. FIG. 20C shows values and processes used for the quantization matrixes shown in FIG. 20B.

This embodiment describes the case where conversion object coefficients of low frequency components in the quantization to matrix are coefficients satisfying u+v≦2, but the value “2” in u+v≦2 may be changed to other values. In addition, the scan order (zigzag scan) (0 to 63) used for coding may be employed. It is also possible to set “scan order (zigzag scan)≦−1”, that is, there is no conversion domain, as in quantization matrix MA shown in FIG. 20B.

It is further possible to set “scan order (zigzag scan) ≦63”, that is, all coefficients are included in a conversion domain, as in quantization matrix MB shown in FIG. 20B. Moreover, any method that can separate low frequency components and high frequency components is applicable. These criteria may not be fixed, and can be changed from picture to picture.

This embodiment describes the case where the conversion factor of conversion object coefficients in the quantization matrix is constant, but the conversion object coefficients may not be converted by a constant conversion factor as in quantization matrix MC shown in FIG. 20B, so long as the following holds true.

converted quantization matrix coefficient)≦(pre-conversion quantization matrix coefficient)×(quantization matrix conversion factor α).

This embodiment describes the case where coefficients in the quantization matrix which are excluded from conversion are not changed, but the principle of the present invention is not affected even when coefficients excluded from conversion are changed as shown by quantization matrix MD in FIG. 20B.

This embodiment describes the case where conversion object coefficients of the quantization matrix are coefficients satisfying u+v≦(fixed value) or in the scan order (zigzag scan), but the present invention is not limited to such. Conversion object coefficients of the quantization matrix may be coefficients that satisfy conditions of u≦(fixed value) and v≦(fixed value), as in quantization matrix ME shown in FIG. 20B.

Moreover, the scan order (alternate scan) may be used as in quantization matrix MF shown in FIG. 20B, or other methods may be used for the determination. In the case of using the scan order, which scan order is used may be determined according to whether the image is a progressive image or an interlaced image, or according to which scan order is used for coding the stream.

This embodiment describes the case where the rate control is performed per MB, but the rate control may not necessarily be performed per MB. For example, all MBs may have a same quantization scale.

In this embodiment, even in the case where the conversion factor is set to 1 times or more, when this conversion factor is smaller than the conversion factor (1/α times) of the quantization matrix for low frequency components, the code amount of the coded data further increases. In the rate conversion, the conversion factor below 1/α times may be permitted, or the conversion factor may be rounded up so as to be equal to or larger than 1/α without permitting the conversion factor below 1/α times.

This embodiment describes the case where the conversion of low frequency components of the quantization matrix is limited to 1/α times (α is an integer), but 1/α times is not a limit for the present invention, and an arbitrary rational number smaller than 1 may be used.

This embodiment describes the case where the conversion of the quantization parameter is limited to an integral multiple, but the present invention is not limited to an integral multiple, and an arbitrary rational number larger than 1 may be used.

This embodiment describes the case where “(conversion factor of quantization matrix)×(conversion factor of quantization parameter)” for low frequency components is equal to or larger than 1, but an arbitrary value smaller than 1 is also applicable as long as it is larger than that of high frequency components.

This embodiment describes the case where a codec using the 6-block structure of 4: 2: 0 (luminance, chrominance, chrominance) is employed, but the present invention can be realized even with an image codec using other block structures such as 4: 2: 2.

This embodiment describes the case where the fractional portion is dropped when converting a quantized DCT coefficient, but the present invention can be realized even when the quantized DCT coefficient is converted to an integer by other methods such as rounding off the fractional portion.

The coding rate conversion apparatus of this embodiment includes the inverse quantization unit and the quantization unit separately from each other. As an alternative, the inverse quantization unit and the quantization unit may be integrated so that the quantized DCT coefficients of the output stream are directly calculated from the quantized DCT coefficients of the input stream.

The coding rate conversion apparatus 1000 of this embodiment directly outputs the quantized DCT coefficients obtained by requantization, but the present invention can also be realized in the case of correcting the quantized DCT coefficients obtained by requantization according to, for example, motion compensation, before outputting them. That is, the present invention is applicable to any method that converts the input stream to the output stream directly by requantization without restoring the image from the input stream.

### Second Embodiment

In the coding rate conversion apparatus 1000 of the first embodiment, the quantization scale can take the value only in the range of 1 to 112 in, for example, MPEG2. Accordingly, when the quantization scale of the input stream is close to 112, quantization scale conversion factor β cannot be made larger. This makes it impossible to compensate for the code amount increase in low frequency components by the quantization matrix, as a result of which the coding rate cannot be reduced sufficiently.

In addition, in the coding rate conversion apparatus 1000 of the first embodiment, each coefficient of the quantization matrix can take the value only in the range of 1 to 255 in MPEG2. Accordingly, when coefficients of low frequency components in the quantization matrix of the input stream are already close to 1 to some extent, quantization matrix conversion factor α of low frequency components cannot be made larger. In such a case, image quality degradation cannot be reduced sufficiently.

A coding rate conversion apparatus for solving the above problems is described in a second embodiment of the present invention.

The following describes the embodiment of the present invention, with reference to drawings.

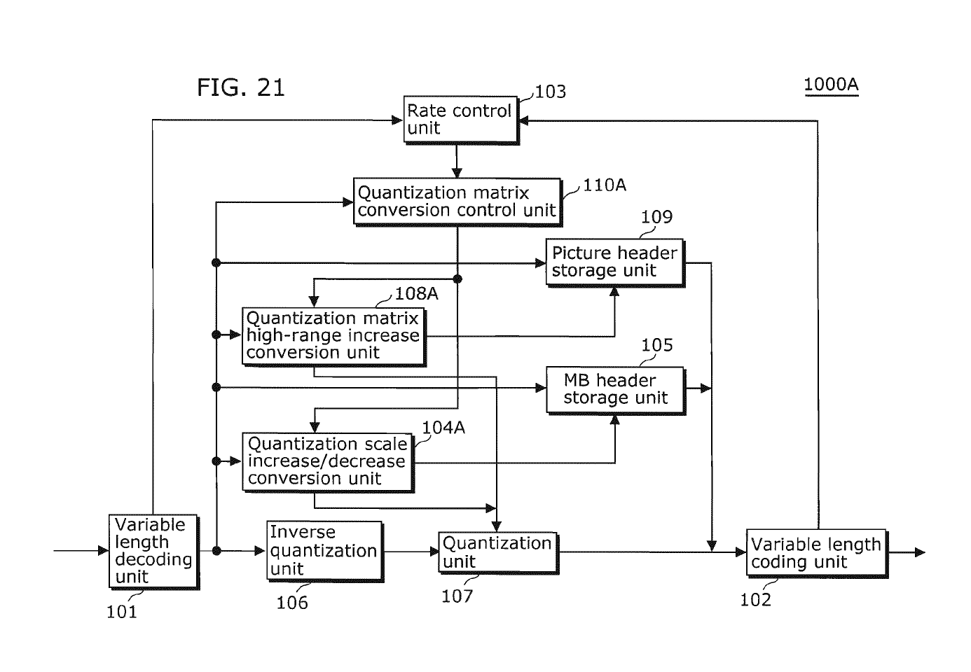

FIG. 21 is a block diagram showing a structure of a coding rate conversion apparatus 1000A in the second embodiment.

The coding rate conversion apparatus 1000A in FIG. 21 differs from the coding rate conversion apparatus 1000 in FIG. 11 in that a quantization matrix conversion control unit 110A is included in place of the quantization matrix conversion control unit 110, a quantization matrix high-range increase conversion unit 108A is included in place of the quantization matrix low-range decrease conversion unit 108, and a quantization scale increase/decrease conversion unit 104A is included in place of the quantization scale increase conversion unit 104. The other parts of the structure are the same as those of the coding rate conversion apparatus 1000, and so their detailed description is not repeated here.

The quantization matrix conversion control unit 110A performs a process where, in the description of the process performed by the quantization matrix conversion control unit 110 in the first embodiment, “quantization matrix low-range decrease conversion unit 108” and “quantization scale increase conversion unit 104” are replaced respectively with “quantization matrix high-range increase conversion unit 108A” and “quantization scale increase/decrease conversion unit 104A”, and so its detailed description is not repeated here.

The quantization matrix conversion control unit 110A, when processing the top picture, calculates quantization matrix conversion control information on the basis of the target code amount of the picture, a quantization matrix conversion achieved value, and the like. The quantization matrix conversion control unit 110A notifies the calculated conversion control information to the quantization matrix high-range increase conversion unit 108A. The quantization matrix conversion control unit 110A also corrects the target quantization scale for each macroblock on the basis of the quantization matrix control information, and notifies the corrected quantization scale to the quantization scale increase/decrease conversion unit 104A.

The quantization matrix high-range increase conversion unit 108A converts coefficients of high frequency components of the quantization matrix of the input stream in an increasing direction, on the basis of the quantization matrix conversion control information. The quantization matrix high-range increase conversion unit 108A simultaneously notifies the converted quantization matrix to the quantization unit 107 and the picture header storage unit 109.

The quantization scale increase/decrease conversion unit 104A converts the quantization scale of the input stream in an increasing direction or a decreasing direction with reference to the target quantization scale or on the basis of significant MB determination, to calculate the quantization scale of the output stream. The quantization scale increase/decrease conversion unit 104A simultaneously notifies the calculated quantization scale to the quantization unit 107 and the MB header storage unit 105.

The following describes a processing flow in the coding rate conversion apparatus of the second embodiment of the present invention, on the basis of the processing flow in the coding rate conversion apparatus of the first embodiment shown in FIGS. 12 to 14.

Steps S301 to S308 and S401 to S407 are the same as the first embodiment, and so their description is omitted. The quantization matrix high-range increase conversion unit 108A converts high frequency components of the quantization matrix of the input stream set in any of Steps S302, S305, and S404 in an increasing direction, according to the quantization matrix conversion control information (Step S408).

Steps S409 to S411 and S501 to S504 are the same as the first embodiment, and so their description is omitted. The quantization scale increase/decrease conversion unit 104A performs the target quantization scale correction, significant MB determination, and the like in Step S502, and converts the input value of the quantization scale of the macroblock in an increasing direction or a decreasing direction. Steps S505 to S513 are the same as the first embodiment, and so their description is omitted.

The following describes a specific operation of rate is control in the coding rate conversion apparatus in the second embodiment of the present invention.

When processing the top picture, target code amount T(i) of the picture needs to be calculated first. Target code amount T(i) can be calculated on the basis of Step 1 of TM5, and so its detailed description is omitted here. Furthermore, the target quantization scale needs to be calculated for each macroblock. The target quantization scale can be calculated on the basis of Step 2 of TM5, and so its detailed description is omitted here.

Though TM5 is mentioned here as a rate control method, other rate control methods are also applicable. The present invention is not dependent on a specific rate control method.

The following describes a specific process of quantization matrix conversion of Step S408 in FIG. 13 performed by the coding rate conversion apparatus 1000A in the second embodiment of the present invention.

Suppose there are the i-th picture and a picture (hereafter referred to as an evaluation object picture) immediately preceding the i-th picture. In such a case, the evaluation object picture is the (i−1)-th picture. It is assumed here that the evaluation object picture is a picture to be displayed before the i-th picture, and the i-th picture and the evaluation object picture are pictures of a same type.

In addition, suppose the quantization matrix conversion factor of high frequency components (high range) is α(i−1) (where α(i−1)>1), and the quantization scale conversion factor mean value is β(i−1). This being the case, quantized DCT coefficient conversion factor γ(i−1) (mean value of high frequency components) can be calculated according to an expression γ(i−1)=α(i−1)×β(i−1).

In the above expression, when γ=1, quantization errors in low range of DCT coefficients are smallest. Furthermore, when γ is reasonably small (denoted by γmax) even though larger than 1, image quality degradation can be considered to be within a permissible range.

In the case where quantization errors are expected to exceed the permissible range, such control that restricts quantization errors within the permissible range is necessary. Meanwhile, when y is smaller than 1, image quality degradation does not occur, but the code amount increases, so that control of making y equal to or larger than 1 is necessary.

Assume the evaluation object picture located closest to the i-th picture has a quantization scale of a same tendency as the i-th picture (β(i)=β(i−1)). In this case, quantization matrix conversion factor (high range) a(i) of the i-th picture can be calculated according to the following expression.

$$a ( i ) = 1 \times a ( i - 1 ) / γ ( i - 1 ) ( where γ ( i - 1 ) < 1 ) a ( i - 1 ) ( where 1 \leq γ ( i - 1 ) \leq γmax ) γ max \times a ( i - 1 ) / γ ( i - 1 ) ( where γmax < γ ( i - 1 ) ) .$$

Next, the quantization matrix of the input stream is converted to quantization matrix Wo(u, v) of the output stream according to the following expression (hereafter referred to as matrix conversion expression B), using quantization matrix conversion factor α(i).

$$Wo ( u , v ) = Wi ( u , v ) ( where u + v \leq ɛ ( low frequency component ) ) a ( i ) \times Wi ( u , v ) ( where u + v > ɛ ( high frequency component ) ) .$$

Here, Wi(u, v) is a constant showing the (u, v)-th coefficient (u=0 to 7, v=0 to 7) of the quantization matrix of the input stream, Wo(u, v) is a constant showing the (u, v)-th coefficient of the quantization matrix of the output stream. Wo(u, v) also shows the coefficient specified by row (v+1) and column (u+1). For instance, when u=2 and v=5, Wo(u, v) shows the coefficient specified by row 6 and column 3. E is a constant showing a frequency threshold (reference frequency) for suppressing errors.

Though the closest picture of the same picture type (evaluation object picture) is selected here as a quantization scale achieved value, the present invention is not limited to this. For example, the evaluation object picture may be selected irrespective of the type of the i-th picture.

Moreover, a picture not closest to the i-th picture may be selected. Further, not a single picture but a plurality of pictures preceding the i-th picture may be selected. Alternatively, a quantization scale calculated by pre-reading the quantization scale of the i-th picture may be used instead of the quantization scale of the picture preceding the i-th picture. The quantization scale may be predicted according to other methods.

In this example, the quantization scale conversion factor mean value is used in the calculation of the quantization matrix conversion factor. However, the present invention is not limited to this. Other achieved values relating to the quantization scale such as a quantization scale conversion factor minimum value, or a fixed value and the like may be used. Moreover, the calculation method of the quantization matrix conversion factor may be irrelevant to the quantization scale.

The following describes a specific operation of quantization scale conversion (quantization scale conversion process in FIG. 15) performed by the coding rate conversion apparatus 1000A in the second embodiment of the present invention.

The target quantization scale calculated by the rate control is based on Step 2 of TM5, and is determined irrespective of the quantization matrix. Therefore, in the coding rate conversion apparatus 1000A of this embodiment, there is a possibility that the quantization scale used is not an optimum quantization scale.

In the case where the quantization matrix conversion factor (high range) is large, the code amount is in a decreasing direction. This being so, when the quantization scale obtained by the rate control is directly used, there is a possibility that the code amount is reduced excessively. In such a case, the target quantization scale may be corrected to be slightly smaller, in order to ease the reduction of the code amount to some extent.

As an example, target quantization scale mq(j) obtained by the rate control may be corrected to

mq′(j)=mq(j)×(1/α).

Though the target quantization scale is corrected by multiplying by 1/α in this example, the code amount of the coded data can also be corrected in an increasing direction with a value, other than 1/α, which is smaller than 1. Moreover, the target quantization scale may be corrected according to other expressions, or the correction may not be performed.

Next, the quantization scale of the macroblock is actually calculated. Quantization scale qo(j) of the output stream can be derived according to the technique disclosed in Japanese Unexamined Patent Application Publication No. 2001-204028 of Patent Reference 2 as a conventional technique, and so its detailed description is omitted here.

$$qo ( j ) = qi ( j ) ( where mq ( j ) < 1.5 qi ( j ) ) 2 \times qi ( j ) ( where 1.5 \times qi ( j ) \leq mq ( j ) < 2 \times qi ( j ) ) mq ( j ) ( where 2 \times qi ( j ) < mq ( j ) ) .$$

Here, qi(j) is the quantization scale of the input stream, and mq(j) is the target quantization scale.

Though quantization scale qo(j) is derived according to the above expression in this example, quantization scale qo(j) may be derived according to other expressions.

By using the above quantization scale, it is possible to perform such conversion that suppresses quantization errors in low frequency components of DCT coefficients.

In the aforementioned significant MB, however, overall image quality degradation can be suppressed more by suppressing quantization errors in not only low frequency components but also high frequency components of DCT coefficients. Therefore, in the significant MB, it is desirable to set such a quantization scale that can suppress quantization errors in all frequency domains.

As noted earlier, the significant MB is such an MB where a result of multiplying a data amount of an MB block unit of the MB and a quantization scale obtained by converting a quantization scale code shown by an MB header unit of the MB exceeds a predetermined value.

Quantization scale qo″(j) corresponding to the significant MB can be calculated according to the following expression.

qo″(j)=1/α×qi(j).

By using quantization scale qo″(j) for the significant MB, such conversion that suppresses quantization errors in all frequency domains can be achieved.

In an MB (normal MB) other than the significant MB, qo(j) mentioned above can be used as the quantization scale.

Note that the significant MB may be determined using the calculation other than the above calculation ((MB block unit data amount)×(quantization scale)).

The following describes an example of quantization scale conversion.

Here, quantization scales before conversion are shown in FIG. 16A. As noted earlier, a plurality of numbers shown in FIG. 16A represent quantization scales which are each set for a different one of a plurality of MBs constituting coded data of a picture.

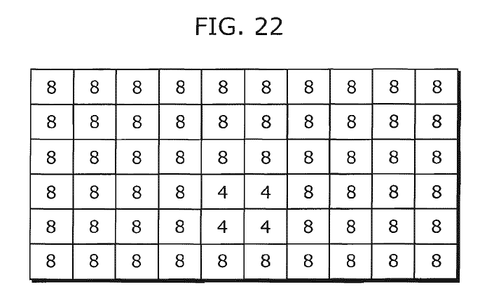

Suppose the quantization scale mean value in rate control based on the target coding rate is “8”. In the case of converting the quantization scale on the basis of the quantization scale mean value, the quantization scale set for each of the MBs corresponding to the upper part of the picture is converted from “4” to “8”, and the quantization scale set for each of the other MBs is held at “8”, as shown in FIG. 22.

When quantization matrix conversion factor α=½, however, quantization scale conversion factor β set for the aforementioned significant MB among the MBs corresponding to the center and lower parts of the picture is set to “½”, in order to minimize quantization errors. Accordingly, the quantization scale set for the significant MB is converted from “8” to “4” in a decreasing direction.

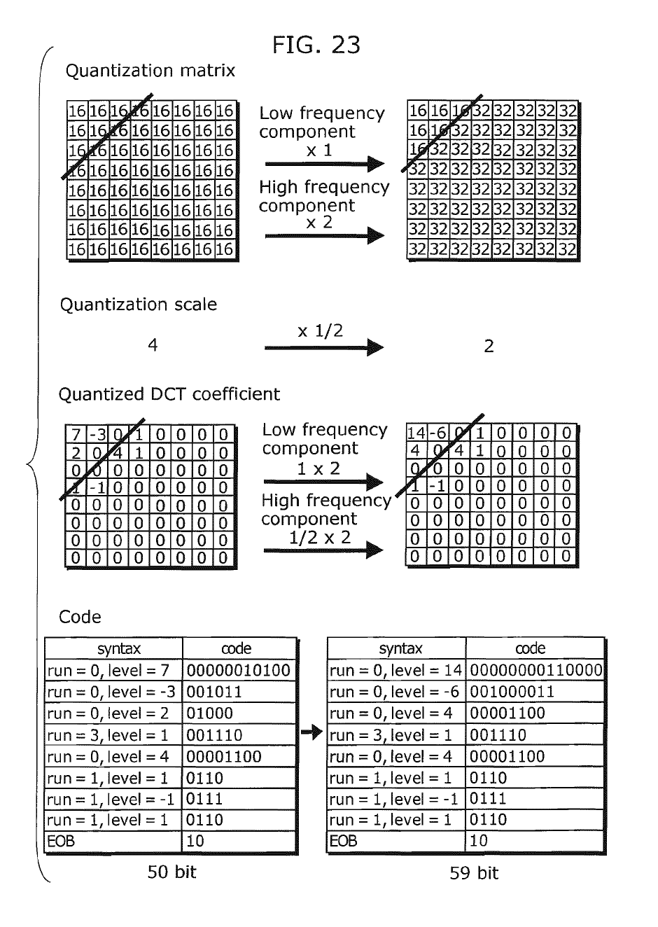

The following describes a specific process of quantization of a significant MB performed by the quantization unit 107 in the coding rate conversion apparatus 1000A in the second embodiment of the present invention, with reference to FIG. 23. The specific process of quantization of a significant MB is performed in Step S509 in FIG. 14.

Suppose coefficients of high frequency components of the quantization matrix (where ε=2) are increased by 2 times as a result of rate control and quantization matrix conversion. That is, quantization matrix conversion factor α of high frequency components is “2”. On the other hand, quantization matrix conversion factor α of low frequency components is “1”,

Moreover, suppose the quantization scale is decreased by ½ times in the significant MB, in order to suppress quantization errors in high frequency components. That is, quantization scale conversion factor 8 is “½”. The quantization scale in this case is calculated in Step S602 in FIG. 16. As a result, the quantization scale “2” is calculated.

Let ε=2 in the above matrix conversion expression B. In such a case, six coefficients located in a top left triangle out of 64 coefficients shown by the quantization matrix are coefficients of low frequency components of the quantization matrix, and coefficients other than the six coefficients located in the top left triangle out of the 64 coefficients shown by the quantization matrix are coefficients of high frequency components of the quantization matrix.

FIG. 23 shows a pre-conversion quantization matrix, a converted quantization matrix, a pre-requantization matrix, and a requantized matrix, as in FIG. 17.

The converted quantization matrix in FIG. 23 is a matrix obtained by the quantization matrix high-range increase conversion unit 108A converting the pre-conversion quantization matrix in FIG. 23 using quantization matrix conversion factor α “2” of high frequency components, in Step S408 in FIG. 13.

In the converted quantization matrix in FIG. 23, the coefficients of the low frequency components are unchanged, while the coefficients of the high frequency components become larger (2 times). Accordingly, when quantization is performed using the converted quantization matrix in FIG. 23, the code amount (coding rate) of the coded data decreases. That is, the converted quantization matrix in FIG. 23 is a matrix for reducing the code amount (coding rate) of the coded data.

The requantized matrix in FIG. 23 is a matrix obtained by the quantization unit 107 requantizing the pre-requantization matrix in FIG. 23 using the converted quantization matrix in FIG. 23 and the calculated quantization scale “2”, in Step S509 in FIG. 14.

With reference to the aforementioned inverse quantization expressions, quantized DCT coefficients need to be approximately in inverse proportion to the quantization matrix and the quantization scale. To do so, quantized DCT coefficients of low frequency components need to be converted by “1 (1/α)×2 (1/β)=2 times”, and quantized DCT coefficients of high frequency components need to be converted by “½ (1/α)×2 (1/β)=1 times”.

Consider the case of converting the pre-requantization matrix in FIG. 23 which is a block of an Inter MB where a total of eight nonzero quantized DCT coefficients 7, −3, 2, 1, 4, 1, −1, and 1 are present and the first three coefficients (7, −3, 2) out of the eight nonzero quantized DCT coefficients correspond to low frequency components.

In this case, the quantized DCT coefficients of the low frequency components are converted to 14, −6, and 4 by 2 times from the input, as shown by the requantized matrix in FIG. 23. On the other hand, the quantized DCT coefficients of the high frequency components need not be converted, as shown by the requantized matrix in FIG. 23.

The quantized DCT coefficients of the low frequency components are integers as long as their conversion factor is an integer, and therefore no quantization errors newly occur. The coefficients of the high frequency components need not be converted from the input, and so quantization errors do not occur.

Thus, though the code amount which is 50 bits at the time of input increases to 59 bits, conversion can be performed with no quantization errors in all frequencies from low frequency components to high frequency components.

When many significant MBs are included in all MBs corresponding to a picture, the above code amount increase presents a serious obstacle to achieving the target rate. However, when the number of significant MBs in all MBs corresponding to the picture is sufficiently small, it is possible to make up for the above code amount increase by reducing the code amount of the other normal MBs.

Accordingly, in the coding rate conversion apparatus 1000A in the second embodiment of the present invention, by making coefficients of low frequency components of the quantization matrix smaller than their input values as a whole, the occurrence of quantization errors in low frequency components can be suppressed, and also the occurrence of quantization errors in high frequency components in significant MBs can be suppressed.

In other words, according to the process of this embodiment, it is possible to suppress image quality degradation caused by quantization errors in low frequency components, and further suppress image quality degradation caused by quantization errors in high frequency components in a specific macroblock as a significant MB.

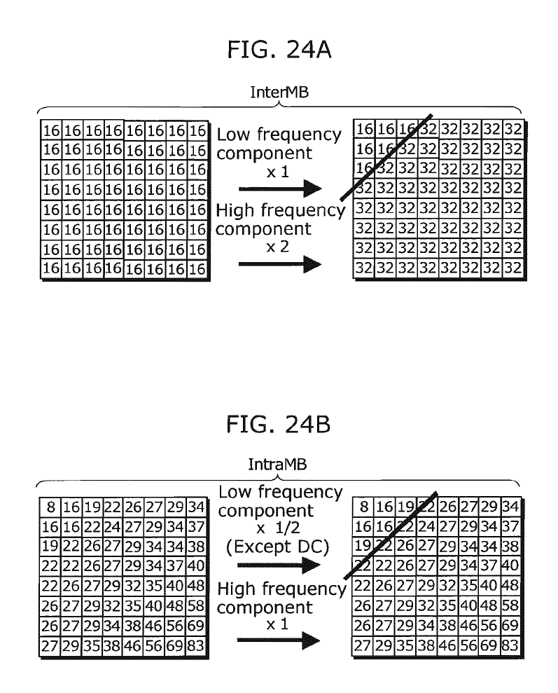

This embodiment describes the case where the type of macroblock is an Inter MB and all coefficients of the quantization matrix are constant, as shown in FIG. 24A. However, the present invention is not limited to this. As shown in FIG. 24B, the process of this embodiment is equally applicable to the case where the type of macroblock is an Intra MB or the coefficients of the quantization matrix are not constant but are varied.

Moreover, the rate conversion using the quantization matrix may be applied to only one of the Inter MB and the Intra MB, or the conversion factor of the quantization matrix and the like may be changed in both the Inter MB and the Intra MB.

The present invention is described on the basis of MPEG2, but the present invention is not limited to MPEG2, and is applicable to any codec which sets the quantization matrix in units of pictures and the quantization parameter in units of macroblocks, such as JPEG, MPEG1, MPEG4, H.264, and so on.

The present invention is described on the basis of a DCT, but other transformation methods may instead be used so long as they are orthogonal transforms that can decompose image data into frequency components.

There is a situation when, as in the present invention, special quantization or coding is conducted in some codecs where a DC component and the like, such as a DC component of an Intra MB of MPEG2, is excluded from the application of the quantization scale. These special coefficients may be excluded from the quantization matrix conversion in the present invention, as shown in FIG. 24B.

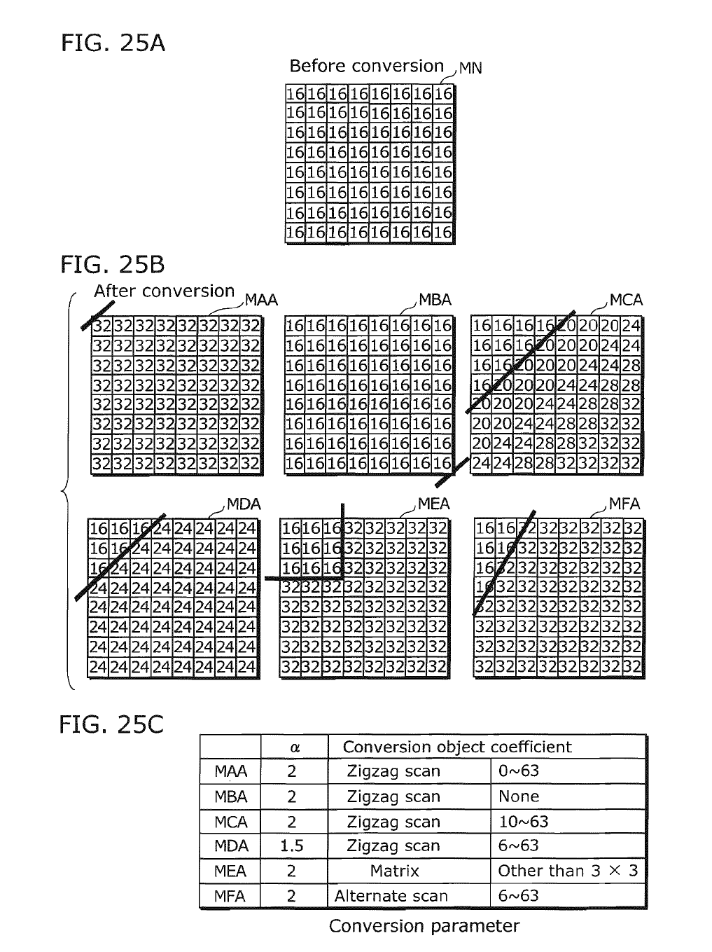

FIG. 25A shows a pre-conversion quantization matrix. FIG. 25B shows converted quantization matrixes according to the process of the second embodiment. FIG. 25C shows values and processes used for the quantization matrixes shown in FIG. 25B.

This embodiment describes the case where conversion object coefficients of high frequency components in the quantization matrix are coefficients satisfying u+v≧3, but the value “3” in u+v≧3 may be changed to other values. In addition, the scan order (zigzag scan) (0 to 63) used for coding may be employed. It is also possible to set “scan order (zigzag scan) ≧0”, that is, all coefficients are included in a conversion domain, as in quantization matrix MAA shown in FIG. 25B.

It is further possible to set “scan order (zigzag scan)≧64”, that is, there is no conversion domain, as in quantization matrix MBA shown in FIG. 25B. Moreover, any method that can separate low frequency components and high frequency components is applicable. These criteria may not be fixed, and can be changed from picture to picture.

This embodiment describes the case where the conversion factor of conversion object coefficients of the quantization matrix is constant, but the conversion object coefficients may not be converted by a constant conversion factor as in quantization matrix MCA shown in FIG. 25B, so long as the following holds true.

(converted quantization matrix coefficient)≦(pre-conversion quantization matrix coefficient)×(quantization matrix conversion factor α).

This embodiment describes the case where the quantization matrix conversion factor is 2 as an example, but other integers larger than 1 are also applicable. For instance, the quantization matrix conversion factor may be a decimal number as long as it is larger than 1, as in quantization matrix MDA shown in FIG. 25B.

This embodiment describes the case where conversion object coefficients of the quantization matrix are coefficients satisfying u+v≦(fixed value) or in the scan order (zigzag scan), but the present invention is not limited to such. Conversion object coefficients of the quantization matrix may be coefficients satisfying a condition of u≧(fixed value) or v≧(fixed value), as in quantization matrix MEA shown in FIG. 25B.

Moreover, the scan order (alternate scan) may be used as in quantization matrix MFA shown in FIG. 25B, or other methods may be used for the determination. In the case of using the scan order, which scan order is used may be determined according to whether the image is a progressive image or an interlaced image, or according to which scan order is used for coding the stream.

This embodiment describes the case where the rate control is performed per MB, but the rate control may not necessarily be performed per MB. For example, all MBs may have a same quantization scale.

This embodiment describes the case where the conversion of high frequency components of the quantization matrix is limited to an integral multiple, but the present invention is not limited to an integral multiple, and an arbitrary rational number larger than 1 may be used.

This embodiment describes the case where the quantization scale conversion factor is limited to 1/α times (α is an integer), but the quantization scale conversion factor may not necessarily be 1/α, and an arbitrary rational number smaller than 1 may be used.

This embodiment describes the case where a codec which uses the 6-block structure of 4: 2: 0 (luminance, chrominance, chrominance) is employed, but the present invention can be realized even with an image codec which uses other block structures such as 4: 2: 2.

This embodiment describes the case where the fractional portion is dropped when converting a quantized DCT coefficient, but the present invention can be realized even when the quantized DCT coefficient is converted to an integer by other methods such as rounding off the fractional portion.

The coding rate conversion apparatus of this embodiment includes the inverse quantization unit and the quantization unit separately from each other. As an alternative, the inverse quantization unit and the quantization unit may be integrated so that the quantized DCT coefficients of the output stream are directly calculated from the quantized DCT coefficients of the input stream.

The coding rate conversion apparatus 1000A of this embodiment directly outputs the quantized DCT coefficients obtained by requantization, but the present invention can be realized even in the case of correcting the quantized DCT coefficients obtained by requantization according to, for example, motion compensation, before outputting them. That is, the present invention can be realized by any method that converts the input stream to the output stream directly by requantization without restoring the image from the input stream.

### Third Embodiment

In the coding rate conversion apparatus 1000A of the second embodiment, the quantization matrix can take the value only in the range of 1 to 255 in MPEG2. Accordingly, when coefficients of the high range (high frequency components) in the quantization matrix of the input stream are already close to 255, quantization matrix conversion factor α of high frequency components cannot be made larger. This makes it impossible to sufficiently reduce the code amount of high frequency components, as a result of which the coding rate cannot be reduced sufficiently.

In addition, in the coding rate conversion apparatus 1000A of the second embodiment, the quantization scale can take the value only in the range of 1 to 112 in MPEG2. Accordingly, when the quantization scale of the input stream is already close to 1, quantization scale conversion factor β in the significant MB cannot be made sufficiently small. This incurs a failure to suppress quantization errors caused by the high-range reduction of the quantization matrix, and leads to image quality degradation.

That is, the coding rate conversion apparatus capable of a quantization process with minimum image quality degradation differs depending on the quantization matrix and the quantization scale of the input stream. In detail, depending on the quantization matrix or the quantization scale, the coding rate conversion apparatus 1000 in the first embodiment shown in FIG. 11 may be capable of performing quantization with minimum image quality degradation. The coding rate conversion apparatus 1000 is an apparatus that performs quantization matrix low-range decrease conversion for converting the quantization matrix. The quantization matrix low-range decrease conversion is conversion that decreases coefficients of low frequency components in the quantization matrix to be converted.

Moreover, depending on the quantization matrix or the quantization scale, the coding rate conversion apparatus 1000A in the second embodiment shown in FIG. 21 may be capable of performing quantization with minimum image quality degradation. The coding rate conversion apparatus 1000A is an apparatus that performs quantization matrix high-range increase conversion for converting the quantization matrix. The quantization matrix low-range decrease conversion is conversion that increases coefficients of high-frequency components in the quantization matrix to be converted.

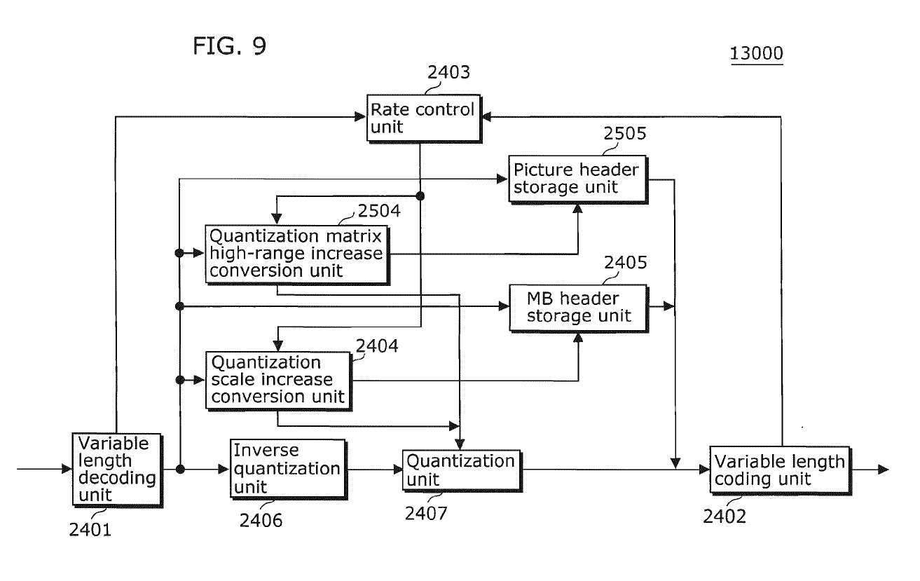

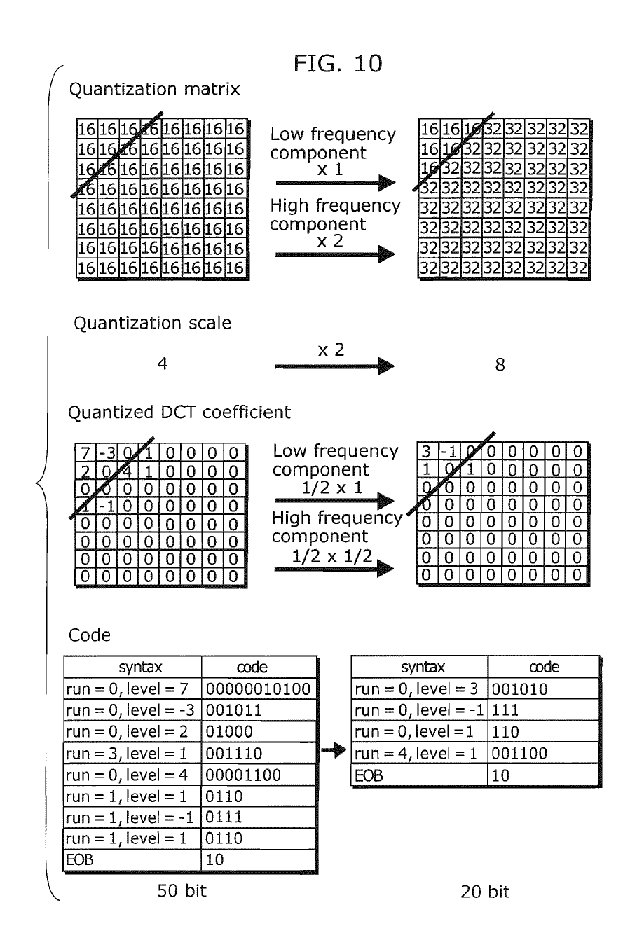

Furthermore, depending on the quantization matrix or the quantization scale, the conventional coding rate conversion apparatus 13000 shown in FIG. 9 may be capable of performing quantization with minimum image quality degradation.

A coding rate conversion apparatus for solving the above problems is described in a third embodiment of the present invention.

The following describes the embodiment of the present invention, with reference to drawings.

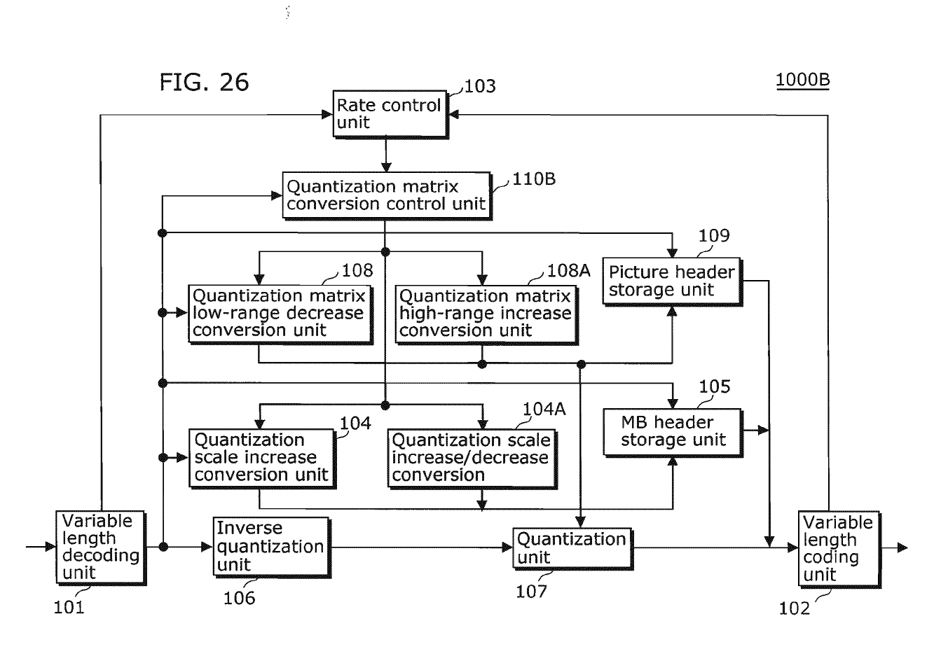

FIG. 26 is a block diagram showing a structure of a coding rate conversion apparatus 1000B in the third embodiment.

The coding rate conversion apparatus 1000B in FIG. 26 differs from the coding rate conversion apparatus 1000 in FIG. 11 in that a quantization matrix conversion control unit 110B is included in place of the quantization matrix conversion control unit 110, and the quantization matrix high-range increase conversion unit 108A and the quantization scale increase/decrease conversion unit 104A are newly included. The other parts of the structure are the same as those of the coding rate conversion apparatus 1000, and so their detailed description is not repeated.

The quantization matrix conversion control unit 110B, when processing the top picture, determines which of quantization matrix low-range decrease conversion and quantization matrix high-range increase conversion is applicable in quantization matrix conversion. This determination will be described in detail later. In the case where both quantization matrix low-range decrease conversion and quantization matrix high-range increase conversion are applicable in quantization matrix conversion, the quantization matrix conversion control unit 110B determines which conversion is applied in quantization matrix conversion.

When applying quantization matrix low-range decrease conversion in quantization matrix conversion, the coding rate conversion apparatus 1000B performs the same process as the coding rate conversion apparatus 1000 in the first embodiment, and so its detailed description is not repeated.

When applying quantization matrix high-range increase conversion in quantization matrix conversion, the coding rate conversion apparatus 1000B performs the same process as the coding rate conversion apparatus 1000A in the second embodiment, and so its detailed description is not repeated.

When applying neither quantization matrix low-range decrease conversion nor quantization matrix high-range increase conversion in quantization matrix conversion, the quantization matrix conversion control unit 110B performs the same process as the conventional coding rate conversion apparatus 13000 in FIG. 9, and so its detailed description is not repeated.

The following describes a specific operation of coding rate conversion method determination in the coding rate conversion apparatus 1000B in the third embodiment of the present invention.

As mentioned earlier, quantization matrix low-range decrease conversion or quantization matrix high-range increase conversion for converting the quantization matrix is not necessarily an optimum method depending on the quantization matrix or the quantization scale. It is therefore desirable to select an optimum method according to the quantization matrix and the quantization scale. However, the quantization scale is coded in a state of being distributed over MB headers of all MBs. Accordingly, to obtain the value of the quantization scale, it is necessary to pre-read the quantization scale of every MB.

To pre-read the quantization scale, the need to decode the input stream twice arises. In view of this, the quantization scale of the same type of picture preceding the processing object picture may be used instead, on the ground that such a quantization scale has the same tendency as the quantization scale of the processing object picture.

First, the quantization matrix conversion control unit 110B determines which of the following four conditions JA, JB, JC, and JD is met by the quantization matrix used for the processing object picture.

(JA) A high-range coefficient maximum value of the quantization matrix is close to a specification upper limit.

(JB) A low-range coefficient minimum value of the quantization matrix is close to a specification lower limit.

(JC) JA and JB are both met.

(JD) JA and JB are both not met.

Next, the quantization matrix conversion control unit 110B determines which of the following four conditions Ja, Jb, Jc, and Jd is met by the quantization scale used for the processing object picture.

(Ja) A quantization scale maximum value is close to a specification upper limit.

(Jb) A quantization scale minimum value is close to a specification lower limit.

(Jc) Ja and Jb are both met.

(Jd) Ja and Jb are both not met.

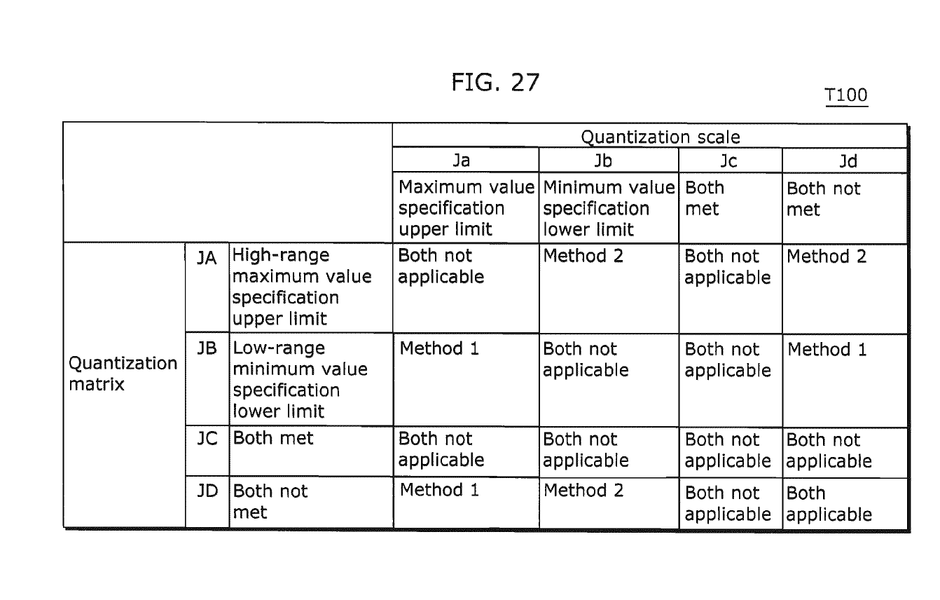

Which coding rate conversion out of quantization matrix low-range decrease conversion (hereafter referred to as method 1) and quantization matrix high-range increase conversion (hereafter referred to as method 2) is suitable for the combination of the above quantization matrix and quantization scale determination results can be determined with reference to a determination table T100 shown in FIG. 27. The determination table T100 is a table for determining whether method 1 or method 2 is applicable in quantization matrix conversion.

“JA”, “JB”, “JC”, and “JD” in the determination table T100 in FIG. 27 are the aforementioned conditions JA, JB, JC, and JD. “Ja”, “Jb”, “Jc”, and “Jd” in the determination table T100 in FIG. 27 are the aforementioned conditions Ja, Jb, Jc, and Jd.

For example, when condition JB and condition Ja are met as a result of the above determination, the determination table T100 is referenced to determine that method 1 (quantization matrix low-range decrease conversion) is suitable for quantization matrix conversion.

Note that both method 1 and method 2 are applicable for the part designated as “both applicable” in the determination table T100 in FIG. 27.

On the other hand, regarding the part designated as “both not applicable” in the determination table T100 in FIG. 27, problems such as an insufficient coding rate reduction and an image quality degradation occurrence arise whichever of method 1 and method 2 is applied. Therefore, it is desirable to apply the conventional coding rate conversion without applying any of the is conversion methods of method 1 and method 2.

Specific operations of rate control, quantization matrix conversion, and quantization scale conversion in the coding rate conversion apparatus 1000B in the third embodiment of the present invention are the same as those of the coding rate conversion apparatus 1000 in the first embodiment and the coding rate conversion apparatus 1000A in the second embodiment, and so their description is omitted here.

This embodiment describes the coding rate conversion apparatus 1000B which combines the coding rate conversion apparatus 1000 in the first embodiment and the coding rate conversion apparatus 1000A in the second embodiment. However, this is not a limit for the present invention. The determination of whether or not to convert the quantization scale is also applicable to the coding rate conversion apparatus 1000 in the first embodiment and the coding rate conversion apparatus 1000A in the second embodiment.

This embodiment describes the case where the maximum value and the minimum value of each of the quantization matrix and the quantization scale are used for determining whether or not to perform quantization matrix conversion, but other reference values such as a mean value may be used instead.

Suppose “(quantization matrix conversion factor (low range) α)×(quantization scale conversion factor β)=1” holds in the process performed by the coding rate conversion apparatus 1000 in the first embodiment. Considering that quantization errors in low frequency components are most suppressed in this case and also that image quality improvement per code amount can be expected when “(quantization scale conversion factor)=2” according to the conventional technique, it is desirable to set quantization matrix conversion factor α=½. However, when coefficients of low frequency components in the quantization matrix are odd numbers, there is a possibility that image quality degradation is caused by conversion errors at the time of quantization matrix conversion.

On the other hand, suppose quantization scale conversion factor 13 is smaller than 1 and also is a real number having a decimal, in the process performed by the coding rate conversion apparatus 1000A in the second embodiment. In this case, the quantization scale is reduced. However, since β is not an integer, when converting to the quantization scale code (quantization parameter) used at the time of coding the quantization scale, the occurrence of conversion errors increases because the quantization scale code is discretely defined with respect to the quantization scale. This can lead to image quality degradation.

In view of the above properties, the determination of whether or not to perform quantization matrix conversion may be made using conversion errors of the quantization matrix or the quantization scale, so as to apply such a method that contributes to fewer conversion errors.

In MPEG2, a quantized DCT coefficient can take the value only in the range of −2047 to 2047. Therefore, in the process performed by the coding rate conversion apparatus 1000 in the first embodiment or the coding rate conversion apparatus 1000A in the second embodiment, when the quantized DCT coefficient in the input stream is already close to −2047 or 2047, the quantized DCT coefficient cannot be increased even in the significant MB, as a result of which image quality degradation may occur.

In view of the above property, the determination of whether or not to perform quantization matrix conversion may be made using quantized DCT coefficients, such as a quantized DCT coefficient maximum value.

### Fourth Embodiment

The coding rate conversion apparatus in the first embodiment is based on the assumption that there is only one type of quantization matrix or that the same conversion is performed on all quantization matrixes. In MPEG2, however, two types of quantization matrixes for the Intra MB and the Inter MB can be defined.

Effects of the occurrence of quantization errors on image quality differ between the Intra MB and the Inter MB of MPEG2. In the Intra MB, there is no reference image, so that quantization errors in low frequency components directly affect image quality. In the Inter MB, on the other hand, quantization errors in low frequency components are errors of differences from a reference image and are not errors from the reference image itself, and so their effects on pixels are often not significant.

Therefore, when the same process of reducing quantization errors in low frequency components is applied to both the Intra MB and the Inter MB, the error reduction in the Inter MB becomes excessive, and can hinder the coding rate reduction.

A fourth embodiment of the present invention is a coding rate conversion apparatus for meeting the above demand.

In H.264 High Profile, the following eight quantization matrixes can be defined.

1. 4×4, Intra MB, luminance

2. 4×4, Intra MB, chrominance (blue component)

3. 4×4, Intra MB, chrominance (red component)

4. 4×4, Inter MB, luminance

5. 4×4, Inter MB, chrominance (blue component)

6. 4×4, Inter MB, chrominance (red component)

7. 8×8, Intra MB, luminance

8. 8×8, Inter MB, luminance

Here, the Intra MB of H.264 is basically intra-frame predicted unlike the Intra MB of MPEG2, and therefore errors of differences from a reference image occur as in the case of the Inter MB. However, the reference image is the same picture and the correlation is low when compared with the Inter MB, so that the effects of quantization errors in the Intra MB on pixels are still significant.

In MPEG2, the block size is fixed at 8×8. In H.264 High Profile, the luminance block size can be selected from 4×4 and 8×8 per macroblock. Meanwhile, the chrominance block size is fixed at 4×4. When the block size is 8×8, there are 64 coefficients. When the block size is 4×4, there are only 16 coefficients. This being so, intended conversion cannot be performed unless the reference frequency for determining low frequency components is changed according to the block size.

The fourth embodiment of the present invention is a coding rate conversion apparatus for meeting the above demand.

Moreover, the effects of quantization errors on the human visual system differ between luminance and chrominance. The human eye is more sensitive to chrominance than luminance, and more sensitive to red chrominance than blue chrominance. Accordingly, when the same quantization error reduction process is applied to luminance, chrominance (blue component), and chrominance (red component), the error reduction for luminance in particular becomes excessive, and can hinder the coding rate reduction.

The fourth embodiment of the present invention is a coding rate conversion apparatus for meeting the above demand.

The following describes the embodiment of the present invention, with reference to drawings.

The coding rate conversion apparatus in the fourth embodiment of the present invention has the same structure as the coding rate conversion apparatus 1000 in the first embodiment shown in FIG. 11, and so its detailed description is not repeated. In the fourth embodiment, the quantization matrix conversion control unit 110 and the quantization matrix low-range decrease conversion unit 108 control/convert a plurality of quantization matrixes independently of each other.

The following describes a specific example of coding rate conversion in the fourth embodiment of the present invention.

As noted earlier, there is the demand to independently change the quantization matrix conversion method according to the block type (luminance, chrominance (blue component), chrominance (red component)), the prediction type (Intra MB or Inter MB), and the block size (8×8, 4×4).

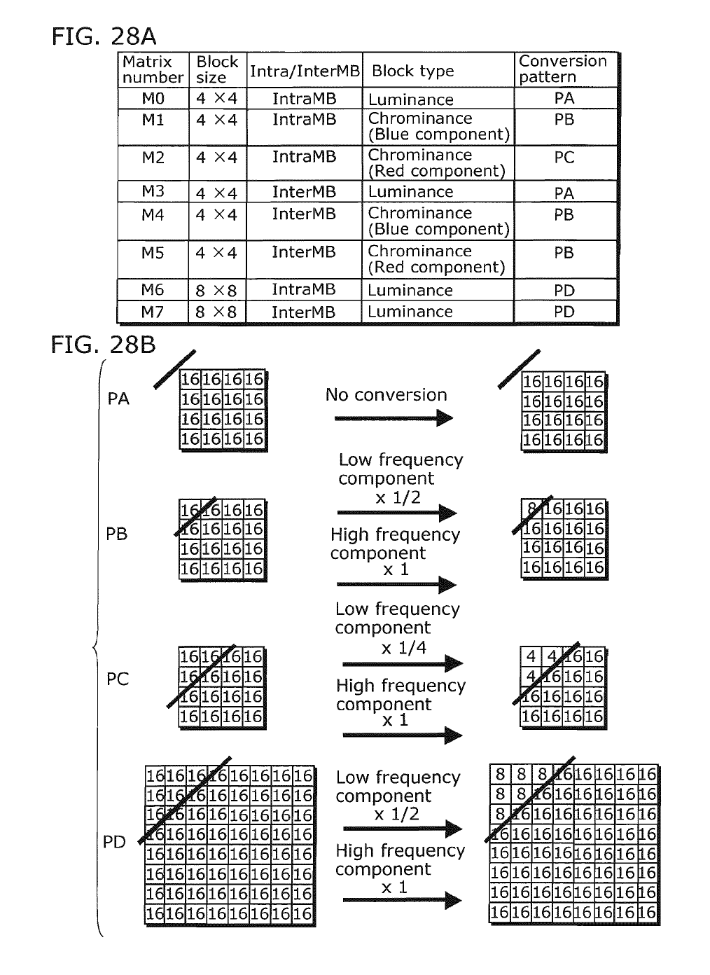

FIGS. 28A and 28B show an example of changing the quantization matrix conversion method according to the block type, the prediction type, and the block size in an H.264 coding rate conversion apparatus. Note that a process of changing the reference frequency and the value (quantization matrix conversion factor) for converting the quantization matrix according to the block type, the prediction type, and the block size is performed by the quantization matrix low-range decrease conversion unit 108.

In conversion pattern PA shown in FIGS. 28A and 28B, the reference frequency for performing low-range conversion is set to a frequency satisfying u+v≦−1, so that there is no conversion of quantization matrix low-range coefficients.

In conversion pattern PB shown in FIGS. 28A and 28B, the reference frequency for performing low-range conversion is set to a frequency satisfying u+v≦1, and the quantization matrix conversion factor is set to ½.

In conversion pattern PC shown in FIGS. 28A and 28B, the reference frequency for performing low-range conversion is set to a frequency satisfying u+v≦2, and the quantization matrix conversion factor is set to ¼.

In conversion pattern PD shown in FIGS. 28A and 28B, the reference frequency for performing low-range conversion is set to a frequency satisfying u+v≦3, and the quantization matrix conversion factor is set to ½.

FIGS. 28A and 28B show an example of conversion where all coefficients of the quantization matrix are 16, but the above conversion patterns are not limited to this quantization matrix. A table shown in FIG. 28A indicates that one of conversion patterns PA to PD is applied according to the combination (matrix numbers MD to M7) of the block size, the prediction type (intra MB or Inter MB), and the block size.

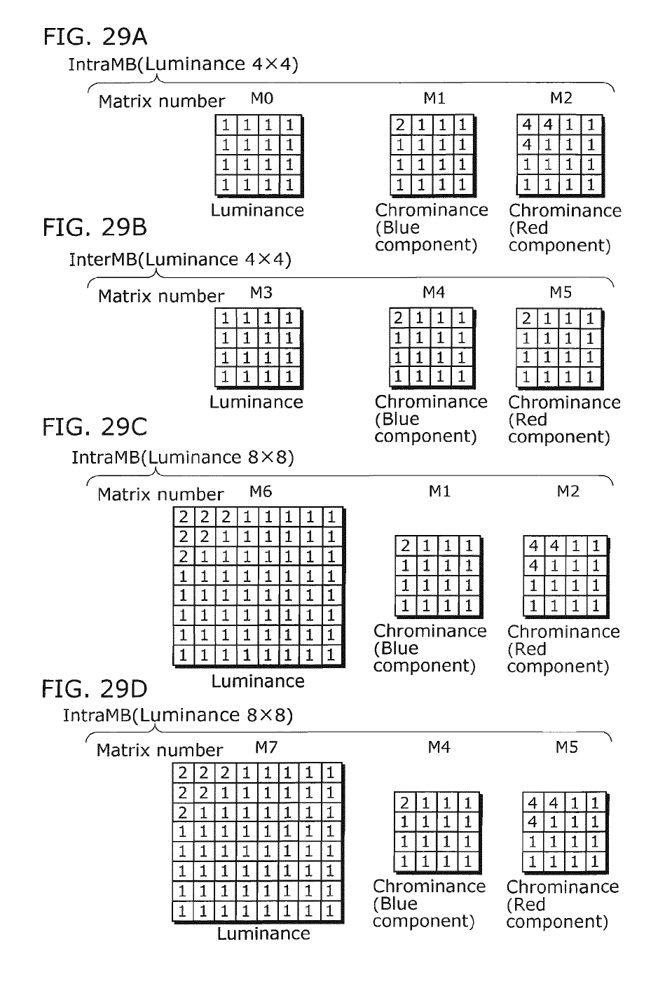

FIGS. 29A, 29B, 29C, and 29D show a conversion factor of quantized DCT coefficients which are converted for each macroblock type of H.264 by the coding rate conversion apparatus in the fourth embodiment, using the converted quantization matrix shown in FIG. 28B.

FIG. 29A shows a conversion factor of quantized DCT coefficients after a luminance MB of 4×4 in size is requantized using a quantization matrix converted according to conversion pattern PA corresponding to matrix number M0. In this case, all quantized DCT coefficients shown by the luminance MB are multiplied by 1 as a result of requantization.

FIG. 29A also shows a conversion factor of quantized DCT coefficients after a chrominance (blue component) MB is requantized using a quantization matrix converted according to conversion pattern PB corresponding to matrix number M1. In this case, only top left one quantized DCT coefficient out of the quantized DCT coefficients shown by the chrominance (blue component) MB is multiplied by 2 as a result of requantization.

FIG. 29A also shows a conversion factor of quantized DCT coefficients after a chrominance (red component) MB is requantized using a quantization matrix converted according to conversion pattern PC corresponding to matrix number M2. In this case, top left three quantized DCT coefficients out of the quantized DCT coefficients shown by the chrorninance (red component) MB are multiplied by 4 as a result of requantization.

Matrixes shown in FIGS. 29B, 29C, and 29D are similar to those shown in FIG. 29A, and so their detailed description is not repeated.

For instance, FIG. 29C shows a conversion factor of quantized DCT coefficients after a luminance MB is inverse quantized using a quantization matrix converted according to conversion pattern PD corresponding to matrix number M6. In this case, top left six quantized DCT coefficients out of the quantized DCT coefficients shown by the luminance MB are multiplied by 2 as a result of inverse quantization.

When the values shown by the matrixes in FIGS. 29A, 29B, 29C, and 29D are larger, the code amount increases, but quantization errors can be reduced.

As described above, by differentiating the quantization error reduction extent in accordance with the combination of the properties of the block type, the prediction type, and the block size, image quality degradation can be suppressed when converting to a required coding rate.

This embodiment describes the case where the block type includes types of luminance, chrominance (blue component), and chrominance (red component), but other types may also be used.

This embodiment describes the case where the prediction type includes Intra and Inter, but other types may also be used.

This embodiment describes the case where the block size includes 8×8 and 4×4, but other sizes may also be used.

This embodiment describes the use of a codec capable of independently defining the quantization matrix according to the block type, the prediction type, and the block size. However, the present invention is not limited to this. Any codec capable of independently defining the quantization matrix according to other attributes may be applied to independently convert the quantization matrix according to these attributes.

This embodiment describes the case where the prediction type and the block size are fixed in the MB, but the present invention can be realized even when the prediction type and the block size are variable in the MB.

This embodiment describes an example of making the quantization matrix conversion factor of the Inter MB lower than the quantization matrix conversion factor of the Intra MB. However, it may be preferable to reverse this in the case where, for example, the inter-frame correlation is low and errors in the Inter MB significantly affect image quality.

The principle of the present invention is to change quantization matrix conversion according to the reference type (Inter MB, Intra MB), and does not depend on which conversion factor is made larger. The same applies to the block type (luminance, chrominance) and the block size (8×8, 4×4).

This embodiment describes the case where the coding rate conversion apparatus 1000 in the first embodiment is used. However, the principle of the present invention is to change the quantization matrix conversion method according to attributes such as the block type, the prediction type, and the block size. Therefore, the present invention is also applicable to the coding rate conversion apparatus 1000A in the second embodiment.

### Fifth Embodiment

The coding rate conversion apparatuses in the first and second embodiments are based on the assumption that there is only one type of quantization scale or that the same conversion is performed on all types of quantization scales. However, the prediction type (Infra MB/Inter MB) changes only in units of macroblocks. Hence it is also possible to change the conversion method between the quantization scale of the Intra MB and the quantization scale of the Inter MB.

Likewise, the block size (luminance 8×8 or 4×4) in H.264 changes only in units of macroblocks, and so it is possible to change the conversion method in the same manner. Note that, though there are a plurality of block types (luminance, chrominance (blue component), and chrominance (red component)) in one macroblock, a common quantization scale is used in MPEG2.

H.264 High Profile has three types of quantization scales that are luminance, chrominance (blue component), and chrominance (red component), but a factor of each quantization scale is fixed in a picture. Accordingly, it is impossible to independently set the three types of quantization scales per macroblock. In a codec capable of independently changing each quantization scale other than MPEG2 and H.264, the quantization scale conversion method can be changed for each quantization scale.

A coding rate conversion apparatus in a fifth embodiment of the present invention has the same structure as the coding rate conversion apparatus 1000 in the first embodiment shown in FIG. 11, and so its detailed description is not repeated.

In the coding rate conversion apparatus in the fifth embodiment of the present invention, the quantization matrix conversion control unit 110 and the quantization scale increase conversion unit 104 change the value (quantization scale conversion factor β) for changing the quantization scale, according to attributes such as the block type (luminance, chrominance (blue component), chrominance (red component)), the prediction type (Intra MB/Inter MB), and the block size in the same way as the fourth embodiment. The other processes are the same as those described in the first embodiment, so that their detailed description is not repeated.

Note that the present invention can also be applied to the coding rate conversion apparatus 1000A in the second embodiment. In this case, the quantization matrix conversion control unit 110A and the quantization scale increase/decrease conversion unit 104A change the value (quantization scale conversion factor β) for changing the quantization scale, according to attributes such as the block type (luminance, chrominance (blue component), chrominance (red component)), the prediction type (Intra MB/Inter MB), and the block size in the same way as the fourth embodiment.

### Sixth Embodiment

This embodiment describes an application example of the coding rate conversion apparatus shown in each of the first to fifth embodiments, or a system using the coding rate conversion apparatus.

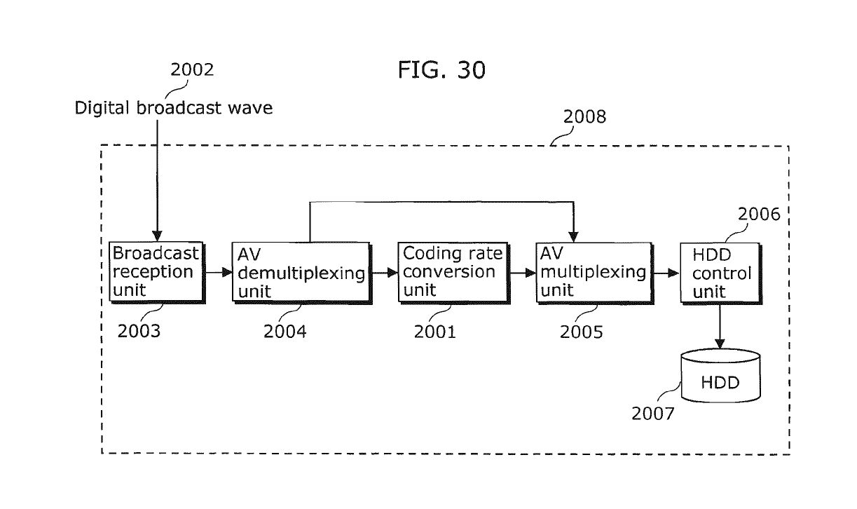

FIG. 30 shows a broadcast stream reception/recording apparatus 2008 using the coding rate conversion apparatus, and a system structure of the broadcast stream reception/recording apparatus 2008. The broadcast stream reception/recording apparatus 2008 includes a coding rate conversion unit 2001, a broadcast reception unit 2003, an AV demultiplexing unit 2004, an AV multiplexing unit 2005, an HDD control unit 2006, and an HDD 2007. Note that the coding rate conversion unit 2001 in the broadcast stream reception/recording apparatus 2008 performs the same process as the coding rate conversion apparatus shown in each of the first to fifth embodiments.

The broadcast stream reception/recording apparatus 2008 operates upon receiving a digital broadcast wave 2002, and converts a coding rate of digital data received from the broadcast wave and records the digital data on the HDD 2007.

The digital broadcast wave 2002 is transmitted over a carrier wave in a modulated state. The digital broadcast wave 2002 contains a plurality of programs. Each of the plurality of programs includes video data coded by MPEG2, audio data coded by AAC, and system data of subtitle information, data broadcasting, and the like.

The broadcast reception unit 2003 demodulates the digital broadcast wave 2002. The broadcast reception unit 2003 separates one desired program from the plurality of programs obtained by the demodulation, and notifies the separated program to the AV demultiplexing unit 2004.

The AV demultiplexing unit 2004 extracts only video data from a stream in which video data, audio data, and system data are multiplexed, and notifies the video data to the coding rate conversion unit 2001. The AV demultiplexing unit 2004 notifies data other than the video data to the AV multiplexing unit 2005.

The coding rate conversion unit 2001 converts the video data to a desired coding rate, and notifies the converted video data (video data whose coding rate has been converted) to the AV multiplexing unit 2005. The AV multiplexing unit 2005 multiplexes the video data whose coding rate has been converted and the original audio data and system data, thereby reconstructing one program. The AV multiplexing unit 2005 notifies the reconstructed program to the HDD control unit 2006. The HDD control unit 2006 records the program on the HDD 2007.

In BS digital broadcasting in Japan, a coding rate of one program is 24 Mbps. This being so, to record a one-hour program on an HDD as it is, the HDD needs to have a capacity of 10 Gbytes or more. Even when the HDD has a capacity of 250 Gbytes, only about 20 hours of programs can be recorded. This creates the demand to record longer hours of problems on the HDD.

The broadcast stream reception/recording apparatus in this embodiment can meet this demand by converting a coding rate of video data to, for example, ½, on the basis of the property that video data makes up about 90% of a program.

This embodiment describes the case where the broadcast stream reception/recording apparatus 2008 receives and processes the digital broadcast wave 2002. However, this is not a limit for the present invention. The broadcast stream reception/recording apparatus 2008 may receive and process a stream recorded on the HDD without coding rate conversion or a stream distributed via a network.

This embodiment describes the case where the data received by the broadcast stream reception/recording apparatus 2008 is recorded on the HDD. However, this is not a limit for the present invention. The data may be recorded on another recording medium, for example, an optical disc such as a DVD or a memory card.

### Seventh Embodiment

This embodiment describes an application example of the coding rate conversion apparatus shown in each of the first to fifth embodiments, or a system using the coding rate conversion apparatus.

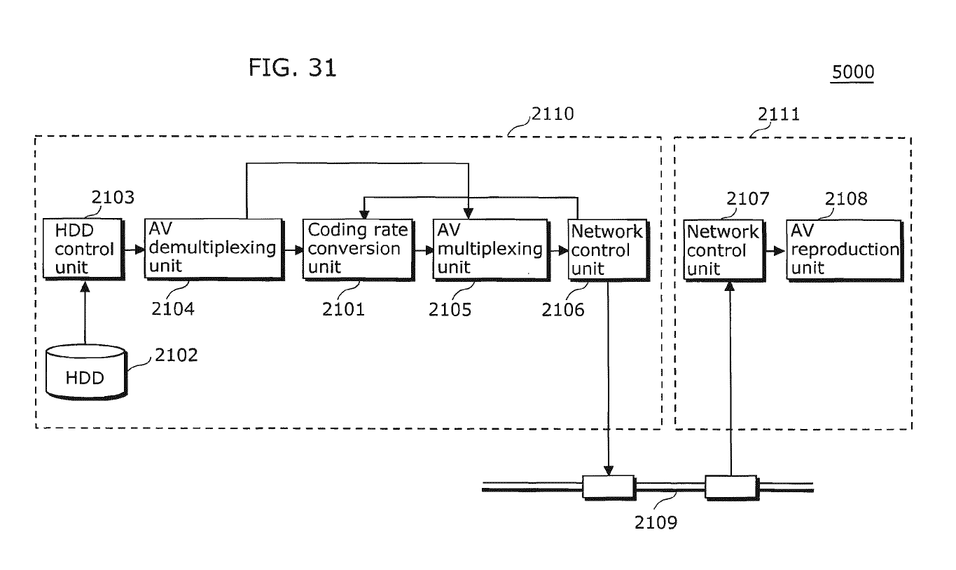

FIG. 31 is a block diagram showing a structure of an example of a network distribution system 5000 using the coding rate conversion apparatus.

The network distribution system 5000 includes a stream transmission apparatus 2110, a stream reception apparatus 2111, and a network 2109. The stream transmission apparatus 2110 transmits a coded stream to the network 2109. The stream reception apparatus 2111 receives the coded stream from the network 2109.

The network distribution system 5000 is a system that distributes an AV stream recorded on an HDD in the stream transmission apparatus 2110 via the network 2109, and reproduces the AV stream in the stream reception apparatus 2111.

The stream transmission apparatus 2110 includes a coding rate conversion unit 2101, an HDD 2102, an HDD control unit 2103, an AV demultiplexing unit 2104, an AV multiplexing unit 2105, and a network control unit 2106. Note that the coding rate conversion unit 2101 in the stream transmission apparatus 2110 performs the same process as the coding rate conversion apparatus shown in each of the first to fifth embodiments. One program including a video stream, an audio stream, and a system stream is stored on the HDD 2102.

The HDD control unit 2103 reads the streams from the HDD 2102, and notifies the read streams to the AV demultiplexing unit 2104. The AV demultiplexing unit 2104 separates only the video stream as in the sixth embodiment, and notifies the separated video stream to the coding rate conversion unit 2101. The AV demultiplexing unit 2104 notifies the streams other than the video stream to the AV multiplexing unit 2105.

The coding rate conversion unit 2101 converts a coding rate of the video stream, and notifies the converted video stream to the AV multiplexing unit 2105. The AV multiplexing unit 2105 generates one AV stream by multiplexing the video stream and the audio and system streams again, and notifies the generated stream to the network control unit 2106.

The network control unit 2106 transmits the received AV stream to the network 2109. The network control unit 2106 detects a coding rate of data transmittable on the network 2109, and notifies information of the detected coding rate to the coding rate conversion unit 2101.

The stream reception apparatus 2111 includes a network control unit 2107 and an AV reproduction unit 2108. The network control unit 2107 receives the AV stream from the network 2109, and notifies the received AV stream to the AV reproduction unit 2108. The AV reproduction unit 2108 demultiplexes and decodes the AV stream, and reproduces video (including data broadcasting and subtitles) and audio. Since the AV reproduction unit is not directly related to coding rate conversion, its detailed structure is omitted here.

For example, in BS digital broadcasting in Japan, a coding rate per program is 24 Mbps. However, since data other than an AV stream is simultaneously transmitted on a network, it is often impossible to ensure a bandwidth of 24 Mbps on the network. Besides, in the case where the network is wireless, a transmittable bandwidth constantly changes depending on signal strength. This further makes it difficult to ensure a bandwidth of 24 Mbps on the network. When the bandwidth cannot be ensured, dropouts of AV stream data occur, as a result of which stream decoding will frequently end up being errors. Hence AV reproduction can hardly be performed.

In the stream transmission apparatus 2110, the network control unit 2106 detects a state of the network 2109, and notifies information of a bandwidth of data transmittable on the network 2109, to the coding rate conversion unit 2101. This allows the coding rate conversion unit 2101 to convert the AV stream to a coding rate transmittable on the network 2109. As a result, dropouts of data on the network 2109 are suppressed. Hence the stream reception apparatus 2111 can successfully perform AV reproduction.

This embodiment describes the case where the data received by the stream transmission apparatus 2110 is the data read from the HDD 2102. However, this is not a limit for the present invention, and the data received by the stream transmission apparatus 2110 may be data contained in a digital broadcast wave or data read from another recording medium.

In the first to seventh embodiments of the present invention, each functional block constituting the coding rate conversion apparatus is typically realized as a program which runs on an information apparatus provided with a CPU and a memory. However, the present invention is not limited to such. Each functional block constituting the coding rate conversion apparatus may be partly or wholly realized as an LSI which is an integrated circuit. Such LSIs may each be implemented individually as one chip, or may be partly or wholly implemented on one chip. Though the LSI is mentioned as the integrated circuit here, any of an IC, a system LSI, a super LSI, an ultra LSI, and the like may be used as the integrated circuit depending on the degree of integration.

Moreover, the integrated circuit method is not limited to an LSI, and may be realized by a dedicated circuit or a general-purpose processor. A Field Programmable Gate Array (FPGA) that can be programmed after LSI manufacturing or a reconfigurable processor capable of reconfiguring connections and settings of circuit cells in an LSI may also be used.

Furthermore, when an integrated circuit technique that replaces an LSI emerges from advancement of semiconductor technologies or other derivative technologies, such a technique can be used for the functional block integration. For instance, biotechnology may be adapted in this way.

The embodiments disclosed here should be considered merely as examples and should not in any sense be interpreted as limitations. The scope of the present invention is shown not by the above description but by the claims, and all variations which are equivalent in meaning and range to the claims are included in the scope of the present invention.

### INDUSTRIAL APPLICABILITY

As described above, for example the coding rate conversion apparatus according to the present invention is useful when reducing a coding rate of a video stream in a broadcast stream reception/recording apparatus, a stream transmission apparatus to a network, and the like.

1. A coding rate conversion apparatus that converts a coding rate of coded data of a picture, the coded data being obtained by performing at least a quantization process using a result of multiplying a quantization matrix and a quantization scale in a process of coding the picture, the quantization scale being set for each of a plurality of macroblocks constituting the coded data for restoring the picture, the quantization matrix being set for the picture obtained from the coded data, said coding rate conversion apparatus comprising:
an inverse quantization unit configured to obtain a plurality of sets of coefficient data, by inverse quantizing the plurality of macroblocks using a first quantization matrix that is used when coding the picture;
a quantization matrix conversion unit configured to convert the first quantization matrix to a second quantization matrix using a first conversion value and a second conversion value, the first conversion value being for converting a low frequency coefficient which is a coefficient corresponding to a frequency lower than a predetermined frequency among a plurality of coefficients shown by the first quantization matrix, the second conversion value being for converting a high frequency coefficient which is a coefficient other than the low frequency coefficient among the plurality of coefficients, the second conversion value being larger than the first conversion value;
a scale calculation unit configured to calculate a converted scale obtained by multiplying a quantization scale corresponding to at least one of the plurality of macroblocks by β1 where β1≧1, when the second quantization matrix is a matrix for increasing the coding rate of the coded data, and to calculate a converted scale obtained by multiplying the quantization scale corresponding to the at least one of the plurality of macroblocks by β2 where 0<β2<1, when the second quantization matrix is a matrix for decreasing the coding rate of the coded data; and
a requantization unit configured to generate the coded data having a coding rate lower than a coding rate prior to the inverse quantization by said inverse quantization unit, by quantizing at least one part of the plurality of sets of coefficient data using the second quantization matrix and a calculated converted scale that corresponds to a macroblock corresponding to the at least one part of the plurality of sets of coefficient data.

2. The coding rate conversion apparatus according to claim 1,
wherein said quantization matrix conversion unit is configured to convert the first quantization matrix to the second quantization matrix, by multiplying the low frequency coefficient by α1 where 0<α1<1.

3. The coding rate conversion apparatus according to claim 2,
wherein said scale calculation unit is configured to calculate a converted scale obtained by multiplying a quantization scale corresponding to each of the plurality of macroblocks constituting the coded data by β3 where β3≧1/α1, when the second quantization matrix is a matrix for increasing the coding rate of the coded data.

4. The coding rate conversion apparatus according to claim 1,
wherein said quantization matrix conversion unit is configured to convert the first quantization matrix to the second quantization matrix, by multiplying the high frequency coefficient by α2 where α2>1.

5. The coding rate conversion apparatus according to claim 1, further comprising
a block determination unit configured to determine whether or not a specific macroblock is included in the plurality of macroblocks, the specific macroblock being a macroblock that shows an image of a resolution higher than a predetermined resolution as a result of being decoded,
wherein said scale calculation unit is configured to calculate a converted scale obtained by multiplying a quantization scale corresponding to each specific macroblock by β1 when said block determination unit determines that the specific macroblock is included and also the second quantization matrix is a matrix for increasing the coding rate of the coded data, and calculate a converted scale obtained by multiplying the quantization scale corresponding to each specific macroblock by β2 when said block determination unit determines that the specific macroblock is included and also the second quantization matrix is a matrix for decreasing the coding rate of the coded data.

6. The coding rate conversion apparatus according to claim 5,
wherein the specific macroblock is a macroblock where a result of multiplying a data amount of the macroblock and a quantization scale corresponding to the macroblock is larger than a predetermined value, among the plurality of macroblocks.

7. The coding rate conversion apparatus according to claim 1,
wherein said quantization matrix conversion unit is configured to, for each of the plurality of macroblocks, change the predetermined frequency and a value for changing at least one part of the plurality of coefficients shown by the first quantization matrix, according to at least one of a type, a prediction method, and a size of the macroblock.

8. The coding rate conversion apparatus according to claim 1,
wherein said scale calculation unit is configured to, for each of the plurality of macroblocks, change β1 or β2 according to at least one of a type, a prediction method, and a size of the macroblock.

9. The coding rate conversion apparatus according to claim 1, further comprising
a determination unit configured to determine whether or not at least one of a first conversion process and a second conversion process is applicable in the conversion of the first quantization matrix, according to the plurality of coefficients shown by the first quantization matrix and the quantization scale corresponding to the at least one of the plurality of macroblocks, the first conversion process being a process of converting the first quantization matrix to the second quantization matrix by multiplying the low frequency coefficient by α1 where 0<α1<1, the second conversion process being a process of converting the first quantization matrix to the second quantization matrix by multiplying the high frequency coefficient by α2 where α2>1,
wherein said quantization matrix conversion unit is configured to, when said determination unit determines any of the first conversion process and the second conversion process as applicable, perform the process determined as applicable, and
said scale calculation unit is configured to calculate the converted scale obtained by multiplying the quantization scale corresponding to the at least one of the plurality of macroblocks by β1 when said quantization matrix conversion unit performs the first conversion process, and calculate the converted scale obtained by multiplying the quantization scale corresponding to the at least one of the plurality of macroblocks by β2 when said quantization matrix conversion unit performs the second conversion process.

10. A coding rate conversion method for converting a coding rate of coded data of a picture, the coded data being obtained by performing at least a quantization process using a result of multiplying a quantization matrix and a quantization scale in a process of coding the picture, the quantization scale being set for each of a plurality of macroblocks constituting the coded data for restoring the picture, the quantization matrix being set for the picture obtained from the coded data, said coding rate conversion method comprising:
obtaining a plurality of sets of coefficient data, by inverse quantizing the plurality of macroblocks using a first quantization matrix that is used when coding the picture;
converting the first quantization matrix to a second quantization matrix using a first conversion value and a second conversion value, the first conversion value being for converting a low frequency coefficient which is a coefficient corresponding to a frequency lower than a predetermined frequency among a plurality of coefficients shown by the first quantization matrix, the second conversion value being for converting a high frequency coefficient which is a coefficient other than the low frequency coefficient among the plurality of coefficients, the second conversion value being larger than the first conversion value;
calculating a converted scale obtained by multiplying a quantization scale corresponding to at least one of the plurality of macroblocks by β1 where β1≧1, when the second quantization matrix is a matrix for increasing the coding rate of the coded data, and calculating a converted scale obtained by multiplying the quantization scale corresponding to the at least one of the plurality of macroblocks by β2 where 0<β2<1, when the second quantization matrix is a matrix for decreasing the coding rate of the coded data; and
generating the coded data having a coding rate lower than a coding rate prior to the inverse quantization, by quantizing at least one part of the plurality of sets of coefficient data using the second quantization matrix and a calculated converted scale that corresponds to a macroblock corresponding to the at least one part of the plurality of sets of coefficient data.

11. An integrated circuit that converts a coding rate of coded data of a picture, the coded data being obtained by performing at least a quantization process using a result of multiplying a quantization matrix and a quantization scale in a process of coding the picture, the quantization scale being set for each of a plurality of macroblocks constituting the coded data for restoring the picture, the quantization matrix being set for the picture obtained from the coded data, said integrated circuit comprising:
an inverse quantization unit configured to obtain a plurality of sets of coefficient data, by inverse quantizing the plurality of macroblocks using a first quantization matrix that is used when coding the picture;
a quantization matrix conversion unit configured to convert the first quantization matrix to a second quantization matrix using a first conversion value and a second conversion value, the first conversion value being for converting a low frequency coefficient which is a coefficient corresponding to a frequency lower than a predetermined frequency among a plurality of coefficients shown by the first quantization matrix, the second conversion value being for converting a high frequency coefficient which is a coefficient other than the low frequency coefficient among the plurality of coefficients, the second conversion value being larger than the first conversion value;
a scale calculation unit configured to calculate a converted scale obtained by multiplying a quantization scale corresponding to at least one of the plurality of macroblocks by β1 where β1≧1, when the second quantization matrix is a matrix for increasing the coding rate of the coded data, and to calculate a converted scale obtained by multiplying the quantization scale corresponding to the at least one of the plurality of macroblocks by β2 where 0<β2<1, when the second quantization matrix is a matrix for decreasing the coding rate of the coded data; and
a requantization unit configured to generate the coded data having a coding rate lower than a coding rate prior to the inverse quantization by said inverse quantization unit, by quantizing at least one part of the plurality of sets of coefficient data using the second quantization matrix and a calculated converted scale that corresponds to a macroblock corresponding to the at least one part of the plurality of sets of coefficient data.
